(19) United States
(12) Patent Application Publication
(10) Pub. No.: US 2024/0099320 A1
(43) Pub. Date: Mar. 28, 2024

(54) DAIRY-BASED PRODUCT, FOOD PRODUCT, METHOD OF PRODUCING AND USE OF THEREOF

(71) Applicant: Arla Foods Amba, Viby J (DK)

(72) Inventors: Jannik Ejnar Elverløv-Jakobsen, Viby J (DK); Jeppe Schøler, Viby J (DK)

(21) Appl. No.: 17/766,980

(22) PCT Filed: Oct. 16, 2020
(86) PCT No.: PCT/EP2020/079241

§ 371 Date: Apr. 6, 2022

(30) Foreign Application Priority Data
Oct. 17, 2019 (EP) 19203763.8

(51) Int. Cl. A23C 9/13; A23C 9/123; A23C 21/06; A23P 30/20

(52) U.S. Cl. CPC A23C 9/1307; A23C 9/123; A23C 21/06; A23P 30/20

(57) ABSTRACT

The present invention relates to a method for preparing a high-protein dairy-based product, a high-protein dairy-based product prepared by the method, a method for producing a food product, the food product prepared by the method and use of the dairy-based product.

### FIELD OF THE INVENTION

The present invention relates to a method for preparing a high-protein dairy-based product, a high-protein dairy-based product prepared by the method, a method for producing a food product, the food product prepared by the method and use of the dairy-based product.

### BACKGROUND

Snacking or grazing has become a global trend. Consumers tend to desire many small meals, which are convenient to eat on-the-go, in the fitness center, at work or at home. The snack marked is diverse and traditionally encompass products with high fat and high sugar content.

Even protein bars targeted sportsmen are candy-like and have considerably high amounts of sugar and fat. However, consumers demand healthy alternatives, which are easy to bring, grap or eat when needed. Additionally, consumers desire products, where the ingredients are natural and healthy and with a transparent label.

One example of a snack bar is the Clio™bar, which is a chocolate bar having a core of a yoghurt-based product. The yoghurt is stabilized with xanthan. The Clio™bar provides 8 grams of protein per bar (50 gram), a total of 170 kcal with an energy distribution of about 41 E % fat, 41 E % carbohydrates and 18 E % protein. (https://cliosnacks.com/Droducts/eanut-butter) International patent application WO2014/058873 discloses a refrigerated or frozen cultured dairy bar having a protein content of about 5-10%. The dairy bar is produced by preparing a cultured dairy composition having more than 38% milk solids and comprises 0.7-1.5% gelatin and a viscosity from about 200,000 cP to about 700,000 cP at 4 degrees C. The yoghurt composition is freezed to form a frozen yoghurt bar and coated with a fat-based coating while freezed. The bar is then thawed and stored cold below 7° C.

International application WO2018/011392 discloses a method for producing acid-gellable whey protein aggregates and use of the particles in the preparation of yoghurt-like products such as drinking yoghurt, stirred-type yoghurt and set-type yoghurt.

WO 2019/206797A1 discloses a method for producing a set-type yogurt snack, said method comprising allowing said yogurt snack to set in a mold or block and wherein said yogurt snack comprises at least 12% (w/w) protein and at least 35% (w/w) total solids.

GB 1 494 502 A discloses a protein food product comprising edible materials selected from thickeners, fats, meats, meat by-products, cereals, proteinaceous vegetable matter, flavouring, permitting colouring matters and nutritional additives incorporated in a matrix composed of heat-coagulated recovered acidic whey protein coagulated at a pH of 6 to 9.

WO 2015/092044 A1 discloses a method to lighten the texture of a fermented dairy product comprising the following successive steps of:
(a) providing a fermented dairy product containing 0.001 to 8 wt % of a texturizing agent and having a solid content comprised between 9.5 and 42 wt % and a total protein content comprised between 2.5 and 25 wt %,
(b) freezing the said fermented dairy product at a temperature below 0 degrees C. to obtain a frozen fermented dairy product, and
(c) thawing the said frozen fermented dairy product at a temperature comprised between 0° C. and 10 degrees C. to obtain a refrigerated fermented dairy product with a lightened texture.

U.S. Pat. No. 4,720,390 A discloses the preparation of thermally gelled emulsions with no addition thickeners or calcium. The preparation involves an aqueous medium containing gellable whey proteins which is homogenized with a lipidic medium under intensive conditions, after which the emulsion is heat-treated. The process may be used for preparing, for example, egg custards, omelettes, pancakes, quiches, sausages, jellies, desserts and spreadable creams.

It is an object of the present invention to provide high-protein food products which are healthy and natural and which could be an alternative to unhealthy snack products.

### SUMMARY OF THE INVENTION

The present invention pertains to a method for preparing a high-protein dairy-based product having a protein content of at least 14% w/w and a dry-matter content of at least 40% w/w, the method comprising
a) combining an acidified dairy product, acid-gellable whey protein aggregates and optionally, at least one further ingredient to obtain a mixture;
b) optionally, shaping and/or packaging the mixture, and
wherein the high-protein dairy-based product is the mixture obtained from step a) and/or step b).

Another aspect of the invention concerns a high-protein, dairy-based product obtainable by the inventive method.

A further aspect of the invention pertains to a method for producing a food product comprising the steps of:
a) Providing a dairy-based product according to the invention;
b) Combining the dairy-based product with at least one further ingredient to obtain the food product; and
c) Optionally, packaging the food product.

An additional aspect of the invention pertains to a food product obtainable by the inventive method for producing a food product.

Yet another aspect of the invention pertains to the use of the dairy-based product or the food product according to the invention for increasing the intake of protein.

### BRIEF DESCRIPTION OF THE FIGURES

FIG. 1 shows the texture of yoghurt bars made from whey powder comprising agWPA compared to MPC, WPC and caseinate.

FIG. 2 shows the high-protein, dairy-based product formed in balls.

FIG. 3 shows the high-protein, dairy-based product right after mixing.

FIG. 4 shows the high-protein, dairy-based product after 3 days storage at 5° C.

FIG. 5 shows the high-protein, dairy-based product formed as bars.

FIG. 6 shows the high-protein, dairy-based product after storage at 5 degrees C. overnight.

FIG. 7 shows the high-protein, dairy-based product shaped into a bar.

FIG. 8 shows the high-protein, dairy-based product of FIG. 4 cut into two half's.

FIG. 9 shows two yoghurt bars coated with chocolate.

FIG. 10 shows the yoghurt bars of FIG. 6 cut in halves.

FIG. 11 shows a zoom in on the cut surface of the two bars in FIG. 7.

### DETAILED DESCRIPTION

In one aspect, the present invention pertains to a method for preparing a high-protein, dairy-based product having a protein content of at least 14% w/w and a dry-matter content of at least 40% w/w, the method comprising
a) combining an acidified dairy product, acid-gellable whey protein aggregates and optionally, at least one further ingredient to obtain a mixture;
b) Optionally, shaping and/or packaging the mixture, and wherein the high-protein dairy-based product is the mixture obtained from step a) and/or step b).

In some preferred embodiments of the invention the method for preparing a high-protein, dairy-based product is for preparing a high-protein, dairy-based product having a protein content of 14-40% w/w and a dry-matter content of at least 40% w/w, the method comprising
a) combining an acidified dairy product, acid-gellable whey protein aggregates and optionally, at least one further ingredient to obtain a mixture;
b) optionally, shaping and/or packaging the mixture, and
wherein the high-protein dairy-based product is the mixture obtained from step a) and/or step b), and preferably wherein the acid-gellable whey protein aggregates constitute 8-20% w/w of the total weight of the dairy-based product.

In another aspect, the invention pertains to a high-protein dairy-based product obtainable by the method of the invention, and preferably wherein the texture of the dairy-based product is at least 20.000 g·sec when measured with the analysis of Example 1.2.

The inventors have found that by the inventive method, it is possible to prepare a self-supporting dairy-based product, which has a high content of protein, comprises probiotic bacteria, has a long shelf-life and has pleasant taste. The inventive method is further advantageous as waste of food is prohibited because surplus of acidified dairy product can be processed into a valuable product such as the dairy-based product.

The dairy-based product obtainable from the method of the invention is self-supporting. The term “self-supporting” means that the dairy-based product has a texture that allows the product to retain its shape when put on a horizontal surface without further support from the sides or top of the product, at least in air, at a pressure of 1 bar and at a temperature of 20 degrees C.

The dairy-based product can be formed, e.g. by extrusion, into the specific shape and retain this shape by supporting itself without reliance on outside aid. The use of extrusion during the shaping step is preferred.

In one embodiment of the invention, the texture of the dairy-based product is at least 20.000 g·sec when measured with the analysis of Example 1.2. In a further embodiment of the invention, the texture of the dairy-based product is at least 25.000 g·sec, preferably at least 30.000 g·sec, more preferably at least 35.000 g·sec, even more preferably at least 35.000 g·sec or most preferred at least 40.000 g·sec.

In an embodiment of the invention, the texture of the dairy-based product may be in the range of 20.000-60.000 g·sec, preferably in the range of 25.000-60.000 g·sec, more preferably in the range of 30.000-60.000 g·sec, even more preferably in the range of 35.000-60.000 g·sec, or most preferred in the range of 40.000-60.000 g·sec when measured with the analysis of Example 1.2.

A high-protein dairy-based product is a product that has a protein content of at least 14% w/w. In one embodiment of the invention the dairy-based product of the invention has a protein content of at least 16% w/w and a dry-matter content of at least 45% w/w, such as a protein content of at least 18% w/w and a dry-matter content of at least 50% w/w, a protein content of at least 20% w/w and a dry-matter content of at least 55% w/w or a protein content of at least 21% w/w and a dry-matter content of at least 50% w/w.

The dairy-based product may have a protein content in the range of 14-40% w/w. Preferably the dairy-based product has a protein content in the range of 16-36% w/w, more preferably in the range of 18-34% w/w, even more preferably in the range of 20-30% w/w and most preferably in the range of 21-28% w/w.

The dry-matter content of the dairy-based product may be at least 45% w/w, preferably at least 50% w/w and more preferably at least 55% w/w. In one embodiment of the invention, the dairy-based product has a dry-matter content in the range of 40-60% w/w, preferably in the range of 45-60% w/w, more preferably in the range of 50-60% w/w or in the range of 55-60% w/w.

In some preferred embodiments of the invention the dairy-based product has a dry-matter content in the range of 40-75% w/w, more preferably in the range of 40-70% w/w, even more preferably in the range of 40-60% w/w, and most preferably in the range of 50-60% w/w.

The dairy-based product of the invention has a protein content of at least 14% w/w and a dry-matter content of at least 40% w/w. The high-protein content of the dairy-based product ensures that the product delivers a high amount of protein to the consumer. In one embodiment of the invention, the dairy-based product has a protein content of at least 16% w/w, preferably at least 18% w/w, more preferably at least 18% w/w, even more preferably at least 20% w/w and most preferably at least 21% w/w.

In one embodiment, the present invention pertains a method for preparing a high-protein dairy-based product having a protein content in the range of 14-40% w/w and a dry-matter content in the range of 40-60% w/w, the method comprising
a) combining an acidified dairy product, acid-gellable whey protein aggregates and optionally, at least one further ingredient to obtain a mixture;
b) optionally, shaping and/or packaging the mixture, and wherein the high-protein dairy-based product is the mixture obtained from step a) and/or step b).

Preferably, the present invention pertains a method for preparing a high-protein dairy-based product having a protein content in the range of 16-36% w/w and a dry-matter content in the range of 45-60% w/w, the method comprising
a) combining an acidified dairy product, acid-gellable whey protein aggregates and optionally, at least one further ingredient to obtain a mixture;
b) optionally, shaping and/or packaging the mixture, and wherein the high-protein dairy-based product is the mixture obtained from step a) and/or step b).

More preferred, the present invention pertains a method for preparing a high-protein dairy-based product having a protein content in the range of 18-34% w/w and a dry-matter content in the range of 50-60% w/w, the method comprising
a) combining an acidified dairy product, acid-gellable whey protein aggregates and optionally, at least one further ingredient to obtain a mixture;
b) optionally, shaping and/or packaging the mixture, and wherein the high-protein dairy-based product is the mixture obtained from step a) and/or step b).

Most preferred, the present invention pertains a method for preparing a high-protein dairy-based product having a protein content in the range of 20-30% w/w and a dry-matter content in the range of 55-60% w/w, the method comprising
a) combining an acidified dairy product, acid-gellable whey protein aggregates and optionally, at least one further ingredient to obtain a mixture;
b) Optionally, shaping and/or packaging the mixture, and wherein the high-protein dairy-based product is the mixture obtained from step a) and/or step b).

In the context of the present invention, the term “dairy-based product” relates to a product comprising milk-based protein and where at least 50% w/w of the protein consist of milk-based protein. The “dairy-based product” may comprise at least 60% w/w of milk-based protein based on the total protein content, such as at least 70% w/w of milk-based protein based on the total protein content, at least 80% w/w of milk-based protein based on the total protein content, at least 90% w/w of milk-based protein based on the total protein content or at least 95% w/w of milk-based protein based on the total protein content.

In the context of the present invention the terms “high-protein dairy-based product” and “dairy-based product” are used interchangeable.

The dairy-based product comprises an acidified dairy product. Acidified dairy products are wellknown in the art. The acidified dairy product can be prepared by fermenting a raw material with a starter culture or by chemical acidification of the raw material. The raw material may be milk. The raw material may contain fat and/or protein of vegetable origin.

Milk can be obtained from cows, sheep, goats, camels, mares or any other animal that produces milk suitable for human consumption. Preferably the milk is cow milk. The milk may be pre-processed as desired to adjust protein, fat and/or lactose content to a desired level. The raw material can be selected from whole milk, cream, low fat milk, skim milk, buttermilk, colostrum, lowlactose milk, lactose-free milk, whey protein depleted milk, reconstituted (recombined)milk made from caseinates, milk powder and water, or a combination thereof.

In the context of the present invention, the term “milk-based protein” means a protein that is present in milk, e.g. casein and whey protein.

In one embodiment of the invention, the acidified dairy product has a pH below 6, such as below 5.5, below 5.0 or below 4.5. The pH of the acidified dairy product may be in the range of 3.5-6, preferably in the range of 4.0-5.5, more preferably in the range of 4.0-5.0 and most preferably in the range of 4.2-4.5.

The pH of the acidified dairy product is preferably below 5.5 and most preferably in the range of 4.0-5.0.

The acidified dairy product may be selected from a strained yoghurt, a stirred yoghurt, cream cheese, fresh cheese or a mixture thereof. Examples of such acidified dairy products are Greek yoghurt, skyr, quark and cream cheese.

Acidified dairy product in the form of Greek yoghurt or mixtures Greek yoghurt of is particularly preferred.

The acidified dairy product may have a fat content in the range of 0.5-30% w/w. In one embodiment of the invention, the acidified dairy product has a fat content in the range of 0.5 to 12% w/w, preferably in the range of 1-11% w/w or in the range of 2-10% w/w. In another embodiment, the acidified dairy product has a fat content in the range of 20-30% w/w, preferably in the range of 22-28% w/w or in the range of 24-26% w/w.

The acidified dairy product contributes to the dry-matter content of the dairy-based product.

The acidified dairy product may have a dry-matter content in the range of 15-55% w/w. In one embodiment of the invention the acidified dairy product has a dry-matter content in the range of 15-25% w/w, preferably in the range of 18-20% w/w. In another embodiment, the acidified dairy product has a dry-matter content in the range of 45-55% w/w, preferably in the range of 48-52% w/w.

The acidified dairy product may have a protein content in the range of 3-20% w/w, preferably in the range of 4-8% w/w or in the range of 9-15% w/w.

In some preferred embodiments of the invention the acidified dairy product has a protein content in the range of 3-20% w/w, more preferably 4-15% w/w, and even more preferably 8-15% w/w, and most preferably 9-15% w/w.

In some preferred embodiments of the invention the acidified dairy product has:
a protein content in the range of 3-20% w/w, more preferably 4-15% w/w, and even more preferably 8-15% w/w, and most preferably 9-15% w/w, and
a fat content in the range of 0.5-30% w/w.

In other preferred embodiments of the invention the acidified dairy product has:
a protein content in the range of 3-20% w/w, more preferably 4-15% w/w, and even more preferably 8-15% w/w, and most preferably 9-15% w/w, and
a fat content in the range of 0.5-12% w/w.

In further preferred embodiments of the invention the acidified dairy product has:
a protein content in the range of 3-20% w/w, more preferably 4-15% w/w, and even more preferably 8-15% w/w, and most preferably 9-15% w/w, and
a fat content in the range of 1-11% w/w.

In some preferred embodiments of the invention the acidified dairy product has:
a protein content in the range of 3-20% w/w, more preferably 4-15% w/w, and even more preferably 8-15% w/w, and most preferably 9-15% w/w, and
a fat content in the range of 0.5-3% w/w.

In some preferred embodiments of the invention the acidified dairy product has:
a protein content in the range of 3-20% w/w, more preferably 4-15% w/w, and even more preferably 8-15% w/w, and most preferably 9-15% w/w,
a fat content in the range of 0.5-30% w/w, and
a dry-matter content in the range of 15-55% w/w.

In other preferred embodiments of the invention the acidified dairy product has:
a protein content in the range of 3-20% w/w, more preferably 4-15% w/w, and even more preferably 8-15% w/w, and most preferably 9-15% w/w,
a fat content in the range of 0.5-12% w/w, and
a dry-matter content in the range of 15-55% w/w.

In further preferred embodiments of the invention the acidified dairy product has:
a protein content in the range of 3-20% w/w, more preferably 4-15% w/w, and even more preferably 8-15% w/w, and most preferably 9-15% w/w,
a fat content in the range of 1-11% w/w, and
a dry-matter content in the range of 15-55% w/w.

In some preferred embodiments of the invention the acidified dairy product has:
a protein content in the range of 3-20% w/w, more preferably 4-15% w/w, and even more preferably 8-15% w/w, and most preferably 9-15% w/w,
a fat content in the range of 0.5-3% w/w, and
a dry-matter content in the range of 15-25% w/w.

The acidified dairy product preferably contributes with 5-50% w/w of the total protein content of the high-protein dairy-based product, more preferably 10-40% w/w, even more preferably 12-30% w/w, and most preferably 14-25% w/w of the total protein content of the high-protein dairy-based product.

The acidified dairy product preferably comprise probiotic bacteria such as viable lactic acid bacteria, which may be recognized for its contribution to maintaining a healthy gut flora. The lactic bacteria may be selected from Lactobacillus Acidophilus, Streptococcus thermophiles and Lactobacillus delbrueckii subsp. Bulgaricus. The acidified dairy product is preferably used in an amount sufficient to provide the high-protein dairy-based product with at least 2.5 million viable lactic acid bacteria per gram of the high-protein dairy-based product, more preferably at least 3.0 million viable lactic acid bacteria per gram of the high-protein dairy-based product.

The acidified dairy product preferably contributes with 25-80% w/w of weight of the high-protein dairy-based product, more preferably 30-70% w/w, even more preferably 35-65% w/w, and most preferably 40-60% w/w of the weight of the high-protein dairy-based product.

The mixture and the high-protein dairy-based product has the same compositional features.

Compositional features mentioned in the context of the high-protein dairy-based product therefore also apply to the mixture and vice versa.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with acid-gellable whey protein aggregates and optionally, at least one further ingredient to obtain a mixture;
b) optionally, shaping and/or packaging the mixture, and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with acid-gellable whey protein aggregates and optionally, at least one further ingredient to obtain a mixture;
b) optionally, shaping and/or packaging the mixture, and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with acid-gellable whey protein aggregates and optionally, at least one further ingredient to obtain a mixture;
b) Optionally, shaping and/or packaging the mixture, and
wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with acid-gellable whey protein aggregates and optionally, at least one further ingredient to obtain a mixture;
b) optionally, shaping and/or packaging the mixture, and
wherein the high-protein dairy-based product is the mixture obtained from step a) and/or step b).

The inventors have found that the acidified dairy product contributes to the pleasant taste of the product.

In one embodiment of the invention, the invention pertains to a method for preparing a high-protein dairy-based product having a protein content of at least 14% w/w and a dry-matter content of at least 40% w/w, the method comprising
a) combining an acidified dairy product, at least 8% w/w of acid-gellable whey protein aggregates and optionally, at least one further ingredient to obtain a mixture;
b) optionally, shaping and/or packaging the mixture, and
wherein the high-protein dairy-based product is the mixture obtained from step a) and/or step b).

In one embodiment, in step a) of the inventive method, an acidified dairy product is combined with at least 9% w/w of acid-gellable whey protein aggregates based on the total weight of the dairy-based product, preferably at least 10% w/w, at least 11% w/w, at least 12% w/w at least 13% w/w or at least 14% w/w of acid-gellable whey protein aggregates based on the total weight of the dairy-based product.

The inventors have found that even though the dairy-based product comprises 8-20% w/w acid-gellable whey protein aggregates, the taste of the dairy-based product is excellent without any taste of powder, as demonstrated in example 2.

The acid-gellable whey protein aggregates may constitute in the range of 8-20% w/w of acidgellable whey protein aggregates based on the total weight of the dairy-based product, preferably in the range of 9-18% w/w, in the range of 10-16% w/w or in the range of 12-14% w/w based on the total weight of the dairy-based product.

The acid-gellable whey protein aggregates may constitute in the range of 8-20% w/w based on the total weight of the dairy-based product, preferably in the range of 9-18% w/w, more preferably in the range of 10-16% w/w, and most preferably in the range of 12-14% w/w based on the total weight of the dairy-based product.

The acid-gellable whey protein aggregates contribute to the total protein content of the dairy-based product. In one embodiment of the invention, the acid-gellable whey protein aggregates constitute at least 40% w/w of the total protein in the dairy-based product, preferably at least 50%, more preferably at least 55% w/w, even more preferably at least 60% w/w or at least 65% w/w of the total protein in the dairy-based product.

In one embodiment of the invention, the acid-gellable whey protein aggregates constitute in the range of 40-70% w/w of the total protein in the dairy-based product. The acid-gellable whey protein aggregates may constitute in the range of 45-68% w/w of the total protein in the dairy-based product, in the range of 50-68% w/w, in the range of 55-68 or in the range of 60-68% w/w of the total protein in the dairy-based product.

In one embodiment of the invention, the acid-gellable whey protein aggregates may constitute at least 10% w/w based on the total weight of the dairy-based product, preferably at least 12% w/w based on the total weight of the dairy-based product or at least 14% w/w based on the total weight of the dairy-based product. The acid-gellable whey protein aggregates may constitute in the range of 10-20% w/w based on the total weight of the dairy-based product, preferably in the range of 12-18% w/w or more preferred in the range of 14-16% w/w.

The source(s) providing acid-gellable whey protein aggregates preferably contributes with 50-95% w/w of the total protein content of the high-protein dairy-based product, more preferably 60-90% w/w, and more preferably 70-88% w/w, and most preferably 75-86% w/w of the total protein content of the high-protein dairy-based product.

Based on the dry-matter content of the dairy-based product, the acid-gellable whey protein aggregates may constitute at least 15% w/w, preferably in the range of 18-16% w/w or more preferred in the range of 20-24% w/w. The acid-gellable whey protein aggregates may constitute in the range of 15-30% w/w based on the dry-matter content of the dairy-based product, preferably in the range of 18-16% w/w or more preferred in the range of 20-24% w/w.

The inventors have found that, besides contributing to increasing the protein and dry-matter content of the dairy-based product, the acid-gellable whey protein aggregates contribute to increasing the texture of the dairy-based product. The inventors have e.g. found this to make the high protein dairy-based product better suited for extrusion than prior art products.

In the context of the present invention, the term “whey protein” relates to the proteins which are present in the serum phase of either milk or coagulated milk. The proteins of the serum phase of milk are also sometimes referred to as milk serum proteins or ideal whey. When used herein the term “whey protein” both encompasses the native whey proteins and whey protein in denatured and/or aggregated form.

In the context of the present invention, the term “whey” relates to the liquid composition which is left when casein has been removed from milk. Casein may e.g. be removed by microfiltration providing a liquid permeate which is free of or essentially free of micellar casein but contains the native whey proteins. This liquid permeate is sometimes referred to as ideal whey, serum or milk serum.

Alternatively, the casein may be removed from milk by contacting a milk composition with rennet enzyme, which cleavages kappa-casein into para-kappa-casein and the peptide caseinomacropeptide (CMP), thereby destabilising the casein micelles and causing casein to precipitate. The liquid surrounding the rennet precipitated casein is often referred to as sweet whey and contains CMP in addition to the whey proteins which are normally found in milk.

Casein may also be removed from milk by acid precipitation, i.e. reducing the pH of the milk below pH 4.6 which is the isoelectric point of casein and which causes the casein micelles to disintegrate and precipitate. The liquid surrounding the acid precipitated casein is often referred to as acid whey or casein whey and does not contain CMP.

In the context of the present invention, the term “acid-gellable whey protein aggregates”, relates to aggregates of denatured whey proteins which aggregates are capable of forming strong gels (much stronger than native whey protein) during acidification and which aggregates typically have linear, worm-like, branched or chain-like shapes. The acid-gellable whey protein aggregates are often prepared by heat-denaturation of demineralised whey protein. The acid-gellable whey protein aggregates are e.g. obtainable by heat-denaturation of a demineralised whey protein solution having a pH in the range of 6-9 at a temperature of at least 68 degrees C. for at most 2 hours with or without shear forces acting on the whey protein during the denaturation. The amount of acid-gellable whey protein aggregates of a composition is quantified according to Example 1.1.

The acid-gellable whey protein aggregates may also be produced by heat-denaturation of dissolved whey protein but at lower protein concentrations, typically in the range of 1-5% (w/w) and with a reduced level of calcium. Examples of the production of acid-gellable whey protein aggregates can be found in U.S. Pat. No. 5,217,741, US 2008/0305235, WO 07/110411 (referred to as linear aggregates) or in WO2018/011392, which are incorporated herein by reference.

The acid-gellable whey protein aggregates are preferably produced as outlined on pages 4-24 of WO2018/011392 and features mentioned in these pages regarding the production of acid-gellable whey protein aggregates apply equally to the present invention.

When preparing the high-protein dairy-based product of the invention, an acidified dairy product is combined with acid-gellable whey protein aggregates and optionally, at least one further ingredient to obtain a mixture. The pH of the mixture depends on the pH of the ingredients in the mixture and may be adjusted to a pH of less than 6.0, preferably below 5.5, more preferred below 5.0 or even more preferred below 4.5. In one embodiment of the invention, the pH of the mixture may be in the range of 3.5-6.0, preferably in the range of 4.0-5.5, in the range of 4.0-5.0 and in the range of 4.2-4.5.

A mixture has a protein content of at least 14% w/w. In one embodiment of the invention the mixture has a protein content of at least 16% w/w and a dry-matter content of at least 45% w/w, such as a protein content of at least 18% w/w and a dry-matter content of at least 50% w/w, a protein content of at least 20% w/w and a dry-matter content of at least 55% w/w or a protein content of at least 21% w/w and a dry-matter content of at least 50% w/w.

The mixture may have a protein content in the range of 14-40% w/w. Preferably the mixture has a protein content in the range of 16-36% w/w, more preferably in the range of 18-34% w/w, even more preferably in the range of 20-30% w/w and most preferably in the range of 21-28% w/w.

The dry-matter content of the mixture may be at least 45% w/w, preferably at least 50% w/w and more preferably at least 55% w/w. In one embodiment of the invention, the mixture has a dry-matter content in the range of 40-60% w/w, preferably in the range of 45-60% w/w, more preferably in the range of 50-60% w/w or in the range of 55-60% w/w.

In some preferred embodiments of the invention the mixture has a dry-matter content in the range of 40-75% w/w, more preferably in the range of 40-70% w/w, even more preferably in the range of 40-60% w/w, and most preferably in the range of 50-60% w/w.

The mixture of the invention has a protein content of at least 14% w/w and a dry-matter content of at least 40% w/w. In one embodiment of the invention, the mixture has a protein content of at least 16% w/w, preferably at least 18% w/w, more preferably at least 18% w/w, even more preferably at least 20% w/w and most preferably at least 21% w/w.

The acid-gellable whey protein aggregates may constitute in the range of 8-20% w/w of acidgellable whey protein aggregates based on the total weight of the mixture, preferably in the range of 9-18% w/w, in the range of 10-16% w/w or in the range of 12-14% w/w based on the total weight of the mixture.

The acid-gellable whey protein aggregates may constitute in the range of 8-20% w/w based on the total weight of the mixture, preferably in the range of 9-18% w/w, more preferably in the range of 10-16% w/w, and most preferably in the range of 12-14% w/w based on the total weight of the dairy-based product.

The acid-gellable whey protein aggregates contribute to the total protein content of the mixture. In one embodiment of the invention, the acid-gellable whey protein aggregates constitute at least 40% w/w of the total protein in the mixture, preferably at least 50%, more preferably at least 55% w/w, even more preferably at least 60% w/w or at least 65% w/w of the total protein in the mixture.

In one embodiment of the invention, the acid-gellable whey protein aggregates constitute in the range of 40-70% w/w of the total protein in the mixture. The acid-gellable whey protein aggregates may constitute in the range of 45-68% w/w of the total protein in the mixture, in the range of 50-68% w/w, in the range of 55-68 or in the range of 60-68% w/w of the total protein in the mixture.

In one embodiment of the invention, the acid-gellable whey protein aggregates may constitute at least 10% w/w based on the total weight of the mixture, preferably at least 12% w/w based on the total weight of the mixture or at least 14% w/w based on the total weight of the mixture. The acid-gellable whey protein aggregates may constitute in the range of 10-20% w/w based on the total weight of the mixture, preferably in the range of 12-18% w/w or more preferred in the range of 14-16% w/w.

The source(s) providing acid-gellable whey protein aggregates preferably contributes with 50-95% w/w of the total protein content of the mixture, more preferably 60-90% w/w, and more preferably 70-88% w/w, and most preferably 75-86% w/w of the total protein content of the mixture.

Based on the dry-matter content of the mixture, the acid-gellable whey protein aggregates may constitute at least 15% w/w, preferably in the range of 18-16% w/w or more preferred in the range of 20-24% w/w. The acid-gellable whey protein aggregates may constitute in the range of 15-30% w/w based on the dry-matter content of the mixture, preferably in the range of 18-16% w/w or more preferred in the range of 20-24% w/w.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the high-protein dairy-based product is the mixture obtained from step a) and/or step b).

The method may be carried out in a cold environment. This contributes substantially no propagation of the microorganisms during the processing. In one embodiment of the invention, the temperature is kept below 20 degrees C. during the production of the dairy-based product. Preferably, the dairy-based product is produced according to the method of the invention at a temperature below 15 degrees C. or more preferably at a temperature below 10 degrees C. In one embodiment, the method is carried out at a temperature in the range of 0-20 degrees C., preferably in the range of 0-15 degrees C., more preferably in the range of 5-15 degrees C. or even more preferred at a temperature of about 10 degrees C.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment of the invention, the method is carried out in a cold environment and the temperature is not raised above 20 degrees C. This ensures that probiotic microorganisms, such as lactic acid bacteria, proliferate during production of the dairy-based product. The mixture obtained in step a) may be cooled to a temperature below 20 degrees C., preferably at a temperature below 15 degrees C., more preferably at a temperature below 10 degrees C. or even more preferred at a temperature below 5 degrees C. In one embodiment, the obtained mixture is cooled to a temperature in the range of 0-20 degrees C., preferably in the range of 0-15 degrees C., more preferably in the range of 0-10 degrees C. or even more preferred at a temperature of 5 degrees C.

However, if undesired microorganisms (e.g. Bacillus cereus, Listeria monocytogenes, Staphylococcus, Salmonella, Campholybacter, Clostridium perfringens, Escherichia coli) are present in the obtained mixture in addition to probiotic bacteria, the mixture can be heated to reduce the number of microorganisms. In one embodiment of the invention, the mixture is heated to a temperature of at least 70 degrees C. for a duration of time sufficient to obtain at least partial microbial reduction. In a preferred embodiment, the mixture is heated to a temperature of at least 72 degrees C. for a duration sufficient to obtain at least a 5-log₁₀ reduction of viable Escherichia coli, preferably for at least 15 seconds. After heating, the mixture obtained in step a) may be cooled to a temperature below 20 degrees C., preferably at a temperature below 15 degrees C., more preferably at a temperature below 10 degrees C. or even more preferred at a temperature below 5 degrees C. In one embodiment, the mixture may be cooled to a temperature in the range of 0-20 degrees C., preferably in the range of 0-15 degrees C., more preferably in the range of 0-10 degrees C. or even more preferred at a temperature of 5 degrees C.

In one embodiment of the invention, the invention pertains to a method for preparing a high-protein dairy-based product having a protein content of at least 14% w/w and a dry-matter content of at least 40% w/w, the method comprising
a) combining an acidified dairy product, acid-gellable whey protein aggregates and at least one further ingredient to obtain a mixture;
b) optionally, shaping and/or packaging the mixture, and
wherein the high-protein dairy-based product is the mixture obtained from step a) and/or step b) and wherein the further ingredient may be selected from fats, carbohydrates, vitamins, sweeteners, carbohydrate based stabilizers and mixtures thereof.

In one embodiment, the further ingredient is fat selected from animal fat or vegetable fat. The further ingredient may comprise one or more animal fats, such as a milk fat. The milk fat may be derived from cream, acidified cream and/or butter. The vegetable fat may be selected from the group consisting of maize oil, sesame oil, soya oil, soya bean oil, linseed oil, grape seed oil, rapeseed oil, olive oil, groundnut oil, sunflower oil, safflower oil and a combination thereof. Alternatively, where the food ingredient may comprise one or more vegetable fat(s), the fat(s) may be selected from the group consisting of palm fat, palm kernel fat and cocoanut fat and a combination thereof.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates, cream, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates, cream, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates, cream, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates, cream, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In one embodiment of the invention, the further ingredient may be a carbohydrate. The carbohydrate may e.g. comprise di- and/or mono-saccharide. The carbohydrate normally comprises or even consists of sucrose, maltose, lactose, dextrose, glucose, fructose, galactose or a combination thereof. Sucrose is a preferred di-saccharide.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates, cream, sucrose, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates, cream, sucrose, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates, cream, sucrose, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates, cream, sucrose, and optionally, at least one further ingredient to obtain a mixture;
b) shaping and/or packaging the mixture to obtain the dairy-based product; and
   wherein the pH of the mixture is in the range of 3.5-6.0, e.g. by adjusting the pH of the mixture and the method is carried out at a temperature in the range of 5-15 degrees C.

In some preferred embodiments of the invention, the dairy-based product comprises a total amount of carbohydrate in the range of 0.5-15% w/w, preferably in the range of 1-10% w/w or in the range of 1-9% w/w. For example the dairy-based product may comprise in the range of 6-9% w/w of a carbohydrate.

The dairy-based product may furthermore comprise a dietary fibre. The dietary fibre should preferably not contribute to the viscosity of the high-protein dairy product. In a preferred embodiment of the invention, the dietary fibre is selected from fructose oligosaccharide and/or galactose oligosaccharide. Preferably, inulin is used as a prebiotic in the dairy-based product.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In some embodiments of the invention, the further ingredient may be a carbohydrate-based stabilizer. In a preferred embodiment, the carbohydrate-based stabilizer is a hydrocolloid. The carbohydrate-based stabilizer can be selected from the group of xanthan, guar gum, locust bean gum, gum karaya, gum tragacanth, gum Arabic, alginate, pectin, carrageenan, gelatin, gellan and agar.

The further ingredient may furthermore be one or more of non-carbohydrate natural or artificial sweeteners.

In some embodiments, further ingredient may be selected from one or more natural sweetening agent(s) that are not sugars. These natural sweetening agent(s) may be provided as a component of a second sweetening agent, either alone, or in combination with a carbohydrate sweetener, as described. The natural non-carbohydrate sweetening agent(s) may for example be selected from the group consisting of Momordica Grosvenorii (Mogrosides IV or V) extracts, Rooibos extracts, Honeybush extracts, Stevia extract, Rebaudioside A, thaumatin, Brazzein, Glycyrrhyzic acid and its salts, Curculin, Monellin, Phylloducin, Rubusosides, Mabinlin, dulcoside A, dulcoside B, siamenoside, monatin and its salts (monatin SS, RR, RS, SR), hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, erythritol, isomaltulose and/or natural polyols such as maltitol, mannitol, lactitol, sorbitol, inositol, xylitol, threitol, galactitol and combinations thereof.

If used, the total amount of natural sweetener is typically in the range of 0.5-10% w/w, such as for example, in the range of 1-10% w/w. Alternatively, the total amount of natural sweetener may be in the range of 5-10% w/w.

In some embodiments, the further ingredient may be one or more artificial sweetening agent(s). These artificial sweetening agent(s) may be provided as a component of the first sweetener, either alone or in combination with other of the sweeteners as defined above. The artificial non-carbohydrate sweetening agent(s) may for example be selected from the group consisting of Aspartame, Cyclamate, Sucralose, Acesulfame K, neotame, Saccharin, Neohesperidin dihydrochalcone, Stevia extract, Rebaudioside A, thaumatin, Brazzein, Glycyrrhyzic acid and its salts, Curculin, Monellin, Phylloducin, Rubusosides, Mabinlin, dulcoside A, dulcoside B, siamenoside, monatin and its salts (monatin SS, RR, RS, SR) and combinations thereof.

If used, the total amount of artificial sweetening agent(s) is typically in the range of 0.1-1% w/w, such as in the range of 0.1-0.5% w/w. Alternatively, the total amount of artificial sweetener may be in the range of 0.2-0.5% w/w.

In some embodiments of the invention, it is particularly preferred that the sweetener comprises or even consists of one or more high-intensity sweeteners (HIS). HIS are both found among the natural and artificial sweeteners and typically have a sweetening intensity of at least 10 times that of sucrose. Non-limiting examples of useful HIS are Aspartame, Cyclamate, Sucralose, Acesulfame K, neotame, Saccharin, Neohesperidin dihydrochalcone and combinations thereof.

In the context of the present invention, the term “high-intensity sweetener” pertains to a sweetener which provides a sweetness intensity (tested in water at 25 degrees C.) per g that is at least 10 times higher than that the sweetness intensity provided by sucrose.

If used, the total amount of HIS is typically in the range of 0.01-2% w/w. For example, the total amount of HIS may be in the range of 0.05-1.5% w/w. Alternatively, the total amount of HIS may be in the range of 0.1-1.0% w/w.

It may furthermore be preferred that the sweetener comprises or even consists of one or more polyol sweetener(s). Non-limiting examples of useful polyol sweetener are maltitol, mannitol, lactitol, sorbitol, inositol, xylitol, threitol, galactitol or combinations thereof.

If used, the total amount of polyol sweetener is typically in the range of 1-20% w/w. For example, the total amount of polyol sweetener may be in the range of 2-15% w/w. Alternatively, the total amount of polyol sweetener may be in the range of 4-10% w/w.

In a preferred embodiment of the invention, the dairy-based product does not comprise noncarbohydrate natural or artificial sweetener.

The further ingredient may furthermore be selected from one or more vitamin(s), such as vitamin A, vitamin D, vitamin E, vitamin K, thiamine, riboflavin, pyridoxine, vitamin B12, niacin, folic acid, pantothenic acid, biotin, vitamin C, choline, vitamin B8, their salts, their derivatives and combinations thereof.

The content of the one of more vitamins may e.g. be in the range of 0.01-1% w/w based on the weight of the dairy-based product, preferably in the range of 0.1 to 0.5% w/w.

In some preferred embodiments of the invention, the vitamin comprises or even consists essentially of vitamin D.

In some preferred embodiments, the dairy-based product comprises vitamin D in an amount within the range of 0.5-2.5 microgram/100 ml, more preferably, the dairy-based product comprises vitamin D in an amount within the range of 1.0-1.5 microgram/100 ml. Even more preferably, the dairy-based product comprises vitamin D in an amount within the range of 1.1-1.3 microgram/100 ml, more preferably, the dairy-based product comprises vitamin D in an amount within the range of 1.15-1.25 microgram/100 ml. In a preferred embodiment, the dairy-based product comprises vitamin D in an amount of 1.2 microgram/100 ml.

In some embodiments of the invention, the dairy-based product comprises both vitamin D and vitamin K.

In one embodiment of the invention, the further ingredient is a dairy product and the dairy-based product only contain dairy ingredients. This may be appreciated by some consumers as the product can be perceived as more clean and the ingredients on the label are easy to recognize.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates, cream, and optionally, at least one further dairy-based ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates, cream, and optionally, at least one further dairy-based ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates, cream, and optionally, at least one further dairy-based ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates, cream, and optionally, at least one further dairy-based ingredient to obtain a mixture, where the pH of the mixture is in the range of 3.5-6.0, e.g. by adjusting the pH of the mixture;
b) optionally, shaping and/or packaging the mixture, and
wherein the method is carried out at a temperature in the range of 5-15 degrees C. and wherein the high-protein dairy-based product is the mixture obtained from step a) and/or step b).

In one embodiment, the invention pertains to a method for preparing a high-protein dairy-based product having a protein content of at least 14% w/w and a dry-matter content of at least 40% w/w, the method comprising
a) combining an acidified dairy product, acid-gellable whey protein aggregates and at least one further ingredient to obtain a mixture;
b) optionally, shaping and/or packaging the mixture, and
wherein the high-protein dairy-based product is the mixture obtained from step a) and/or step b).

In a preferred embodiment of the invention, the high-protein dairy-based product is the mixture obtained from step a). The mixture can be stored cold, e.g. in bulk, until it is further processed, e.g. by shaping and/or packaging.

In some preferred embodiments, the mixture obtained under step a) is stored at a temperature of 0-10 degrees C. for a period of 1-24 hours before being shaped. In a more preferred embodiment, the mixture is stored at a temperature of 0-5 degrees C. for a period of 1-24 hours or more preferably at a temperature of 0-5 degrees C. for a period of 5-16 hours.

In a preferred embodiment of the invention, the high-protein dairy-based product is the mixture obtained from step b). The mixture obtained under step a) may be shaped to form a specific configuration, e.g. the mixture may be shaped to obtain the form of a bar or to bite-sized pieces to form the high-protein dairy-based product. The mixture can be shaped by extrusion, by moulding or by filling in a container. It is preferred that extrusion is at least involved in the shaping of the high-protein dairy-based product, and the extrusion is preferably combined with a cutting operation to provide the high-protein dairy-based product as bars or bite-size pieces in suitable lengths.

The dairy-based product may further be packaged in any suitable package or container.

The dairy-based product is finally packaged in package or container and cooled in the package/container to 5 degrees C. The containers can hereafter be stored at 5 degrees C. for up to three months.

In a preferred embodiment, the invention pertains to a method for preparing a high-protein dairy-based product having a protein content in the range of 14-40% w/w and a dry-matter content in the range of 40-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) shaping the mixture to form bars and optionally packaging; and
wherein the method is carried out at a temperature in the range of 5-15 degrees C. and wherein the high-protein dairy-based product is the mixture obtained from step a) and/or step b).

In a preferred embodiment, the invention pertains to a method for preparing a high-protein dairy-based product having a protein content in the range of 16-36% w/w and a dry-matter content in the range of 45-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) shaping the mixture to form bars and optionally packaging; and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 18-34% w/w and a dry-matter content in the range of 50-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) shaping the mixture to form bars and optionally packaging; and
wherein the method is carried out at a temperature in the range of 5-15 degrees C. and wherein the high-protein dairy-based product is the mixture obtained from step a) and/or step b).

In a preferred embodiment, the invention concerns a method for preparing a high-protein dairy-based product having a protein content in the range of 20-30% w/w and a dry-matter content in the range of 55-60% w/w, the method comprising
a) combining Greek yoghurt, skyr, quark or cream cheese with at least 8% w/w of acidgellable whey protein aggregates, cream, sucrose, inulin, and optionally, at least one further ingredient to obtain a mixture, where the pH of the mixture is in the range of 3.5-6.0, e.g. by adjusting the pH of the mixture;
b) shaping the mixture to form bars and optionally packaging; and
wherein the method is carried out at a temperature in the range of 5-15 degrees C. and wherein the high-protein dairy-based product is the mixture obtained from step a) and/or step b).

In another aspect, the invention pertains to a high-protein dairy-based product obtainable by the method of the invention, and preferably wherein the texture of the dairy-based product is at least 20.000 g·sec when measured with the analysis of Example 1.2.

The dairy-based product has a high content of protein, may comprise probiotic bacteria and/or prebiotics, has a long shelf-life and has a pleasant taste.

In one embodiment of the invention, the texture of the dairy-based product is at least 20.000 g·sec when measured with the analysis of Example 1.2. In a further embodiment of the invention, the texture of the dairy-based product is at least 25.000 g·sec, preferably at least 30.000 g·sec, more preferably at least 35.000 g·sec, even more preferably at least 35.000 g·sec or most preferred at least 40.000 g·sec.

In an embodiment of the invention, the texture of the dairy-based product may be in the range of 20.000-60.000 g·sec, preferably in the range of 25.000-60.000 g·sec, more preferably in the range of 30.000-60.000 g·sec, even more preferably in the range of 35.000-60.000 g·sec, or most preferred in the range of 40.000-60.000 g·sec when measured with the analysis of Example 1.2.

The high-protein dairy-based product typically has a pH in the range of 3.5-6.0, preferably in the range of 4.0-5.5, more preferably in the range of 4.0-5.0, and most preferably in the range of 4.2-4.5.

The dairy-based product of the invention may comprise probiotic bacteria such as viable lactic acid bacteria, which may be recognized for its contribution to maintaining a healthy gut flora. The product may comprise at least 2.5 million viable lactic acid bacteria per gram of the product, preferably at least 3.0 million viable lactic acid bacteria per gram of the product. The lactic bacteria may be selected from Lactobacillus Acidophilus, Streptococcus thermophiles and Lactobacillus delbrueckii subsp. Bulgaricus.

In a preferred embodiment of the invention, the high-protein dairy-based product obtainable by the method of the invention, and having a texture of at least 20.000 g·sec, comprises at least 2.5 million viable lactic acid bacteria per gram of the product.

In a preferred embodiment of the invention, the high-protein dairy-based product obtainable by the method of the invention, and having a texture of at least 30.000 g·sec, comprises at least 2.5 million viable lactic acid bacteria per gram of the product.

In a preferred embodiment of the invention, the high-protein dairy-based product obtainable by the method of the invention, and having a texture of at least 40.000 g·sec comprises at least 2.5 million viable lactic acid bacteria per gram of the product.

The dairy-based product has a high content of protein and thereby becomes a good protein source for people in need of protein, e.g. for maintaining or building up muscles in sportsmen or for supplementing vegetarian or vegan diet with additional protein. The protein content of the dairy-based product may contribute to the nutritional value with at least 18 Energy % (E %, 18% of the energy in the dairy product comes from protein). In a preferred embodiment, the protein content of the dairy-based product may contribute to the nutritional value with at least 20 E %, more preferably at least 23 E %, even more preferably at least 28 E % and most preferred at least 30 E %.

In a preferred embodiment of the invention, the high-protein dairy-based product obtainable by the method of the invention, and having a texture of at least 20.000 g·sec, comprises at least 2.5 million viable lactic acid bacteria per gram of the product and the protein content of the dairy-based product may contribute to the nutritional value with at least 18 E %.

In a preferred embodiment of the invention, the high-protein dairy-based product obtainable by the method of the invention, and having a texture of at least 30.000 g·sec, comprises at least 2.5 million viable lactic acid bacteria per gram of the product and the protein content of the dairy-based product may contribute to the nutritional value with at least 20 E %.

In a preferred embodiment of the invention, the high-protein dairy-based product obtainable by the method of the invention, and having a texture of at least 40.000 g·sec, comprises at least 2.5 million viable lactic acid bacteria per gram of the product and the protein content of the dairy-based product may contribute to the nutritional value with at least 23 E %.

The nutritional value of the dairy-based product may be in the range of 20-40 E % protein, 30-45 E % fat and 25-35 E % carbohydrate. In a preferred embodiment of the invention, the nutritional value of the dairy-based product may be in the range of 28-35 E % protein, 30-40 E % fat and 28-35 E % carbohydrate.

In a preferred embodiment of the invention, the high-protein dairy-based product obtainable by the method of the invention, and having a texture of at least 20.000 g·sec, comprises at least 2.5 million viable lactic acid bacteria per gram of the product and has a nutritional value distribution of 20-40 E % protein, 30-45 E % fat and 25-35 E % carbohydrate, such as 28-35 E % protein, 30-40 E % fat and 28-35 E % carbohydrate.

In a preferred embodiment of the invention, the high-protein dairy-based product obtainable by the method of the invention, and having a texture of at least 30.000 g·sec, comprises at least 2.5 million viable lactic acid bacteria per gram of the product and has a nutritional value distribution of 20-40 E % protein, 30-45 E % fat and 25-35 E % carbohydrate, such as 28-35 E % protein, 30-40 E % fat and 28-35 E % carbohydrate.

In a preferred embodiment of the invention, the high-protein dairy-based product obtainable by the method of the invention, and having a texture of at least 40.000 g·sec, comprises at least 2.5 million viable lactic acid bacteria per gram of the product and has a nutritional value distribution of 20-40 E % protein, 30-45 E % fat and 25-35 E % carbohydrate, such as 28-35 E % protein, 30-40 E % fat and 28-35 E % carbohydrate.

In a preferred embodiment of the invention, the high-protein dairy-based product obtainable by the method of the invention has a protein content in the range of 14-40% w/w and a dry-matter content in the range of 40-60% w/w and a texture of at least 20.000 g·sec, the product comprises at least 2.5 million viable lactic acid bacteria per gram of the product and has a nutritional value distribution of 20-40 E % protein, 30-45 E % fat and 25-35 E % carbohydrate, such as 28-35 E % protein, 30-40 E % fat and 28-35 E % carbohydrate.

In a preferred embodiment of the invention, the high-protein dairy-based product obtainable by the method of the invention has a protein content in the range of 16-36% w/w and a dry-matter content in the range of 45-60% w/w and a texture of at least 30.000 g·sec, comprises at least 2.5 million viable lactic acid bacteria per gram of the product and has a nutritional value distribution of 20-40 E % protein, 30-45 E % fat and 25-35 E % carbohydrate, such as 28-35 E % protein, 30-40 E % fat and 28-35 E % carbohydrate.

In a preferred embodiment of the invention, the high-protein dairy-based product obtainable by the method of the invention has a protein content in the range of 18-34% w/w and a dry-matter content in the range of 50-60% w/w and a texture of at least 40.000 g·sec, comprises at least 2.5 million viable lactic acid bacteria per gram of the product and has a nutritional value distribution of 20-40 E % protein, 30-45 E % fat and 25-35 E % carbohydrate, such as 28-35 E % protein, 30-40 E % fat and 28-35 E % carbohydrate.

In a preferred embodiment, the invention pertains to a high-protein dairy-based product having a protein content in the range of 14-40% w/w, a dry-matter content in the range of 40-60% w/w, a pH of 3.5-6.0 and comprising Greek yoghurt, and at least 8% w/w of acid-gellable whey protein aggregates, cream, sucrose, inulin, and optionally, at least one further ingredient.

In a preferred embodiment, the invention pertains to a high-protein dairy-based product having a protein content in the range of 16-36% w/w, a dry-matter content in the range of 45-60% w/w, a pH of 3.5-6.0 and comprising Greek yoghurt, and at least 8% w/w of acid-gellable whey protein aggregates, cream, sucrose, inulin, and optionally, at least one further ingredient.

In a preferred embodiment, the invention pertains to a high-protein dairy-based product having a protein content in the range of 18-34% w/w, a dry-matter content in the range of 50-60% w/w, a pH of 3.5-6.0 and comprising Greek yoghurt, and at least 8% w/w of acid-gellable whey protein aggregates, cream, sucrose, inulin, and optionally, at least one further ingredient.

In a preferred embodiment, the invention pertains to a high-protein dairy-based product having a protein content in the range of 20-30% w/w, a dry-matter content in the range of 55-60% w/w, a pH of 3.5-6.0 and comprising Greek yoghurt, and at least 8% w/w of acid-gellable whey protein aggregates, cream, sucrose, inulin, and optionally, at least one further ingredient.

The high-protein dairy-based product is a product that has a protein content of at least 14% w/w. In one embodiment of the invention the high-protein dairy-based product of the invention has a protein content of at least 16% w/w and a dry-matter content of at least 45% w/w, such as a protein content of at least 18% w/w and a dry-matter content of at least 50% w/w, a protein content of at least 20% w/w and a dry-matter content of at least 55% w/w or a protein content of at least 21% w/w and a dry-matter content of at least 50% w/w.

The high-protein dairy-based product may have a protein content in the range of 14-40% w/w. Preferably the high-protein dairy-based product has a protein content in the range of 16-36% w/w, more preferably in the range of 18-34% w/w, even more preferably in the range of 20-30% w/w and most preferably in the range of 21-28% w/w.

The dry-matter content of the high-protein dairy-based product may be at least 45% w/w, preferably at least 50% w/w and more preferably at least 55% w/w. In one embodiment of the invention, the high-protein dairy-based product has a dry-matter content in the range of 40-60% w/w, preferably in the range of 45-60% w/w, more preferably in the range of 50-60% w/w or in the range of 55-60% w/w.

In some preferred embodiments of the invention the dairy-based product has a dry-matter content in the range of 40-75% w/w, more preferably in the range of 40-70% w/w, even more preferably in the range of 40-60% w/w, and most preferably in the range of 50-60% w/w.

The high-protein dairy-based product of the invention has a protein content of at least 14% w/w and a dry-matter content of at least 40% w/w. The high protein content of the high-protein dairy-based product ensures that the product delivers a high amount of protein to the consumer. In one embodiment of the invention, the dairy-based product has a protein content of at least 16% w/w, preferably at least 18% w/w, more preferably at least 18% w/w, even more preferably at least 20% w/w and most preferably at least 21% w/w.

In some preferred embodiments of the invention, the high-protein dairy-based product furthermore comprises a fat. The fat is preferably selected from animal fat or vegetable fat. The the high-protein dairy-based product may comprise one or more animal fats, such as a milk fat.

The milk fat may be derived from cream, acidified cream and/or butter. The vegetable fat may be selected from the group consisting of maize oil, sesame oil, soya oil, soya bean oil, linseed oil, grape seed oil, rapeseed oil, olive oil, groundnut oil, sunflower oil, safflower oil and a combination thereof. Alternatively, where the food ingredient may comprise one or more vegetable fat(s), the fat(s) may be selected from the group consisting of palm fat, palm kernel fat and cocoanut fat and a combination thereof.

The high-protein dairy-based product preferably has a fat content in the range of 0.1-30% w/w, more preferably in the range of 0.5-12% w/w, even more preferably in the range of 1-10% w/w, and most preferably in there range of 2-5% w/w. In other embodiments, the high-protein dairy-based product has a fat content in the range of 20-30% w/w, preferably in the range of 22-28% w/w, and most preferably in the range of 24-26% w/w.

In some preferred embodiments of the invention, the high-protein dairy-based product furthermore comprises carbohydrate. The carbohydrate may e.g. comprise di- and/or mono-saccharide. The carbohydrate normally comprises or even consists of sucrose, maltose, lactose, dextrose, glucose, fructose, galactose or a combination thereof. Sucrose is a preferred di-saccharide.

In some preferred embodiments of the invention, the high-protein dairy-based product comprises a total amount of carbohydrate in the range of 0.5-15% w/w, preferably in the range of 1-10% w/w or in the range of 1-9% w/w. For example the dairy-based product may comprise in the range of 6-9% w/w of carbohydrate.

The high-protein dairy-based product may furthermore comprise a dietary fibre. The dietary fibre should preferably not contribute to the viscosity of the high-protein dairy product. In a preferred embodiment of the invention, the dietary fibre is selected from fructose oligosaccharide and/or galactose oligosaccharide. Preferably, inulin is used as a prebiotic in the dairy-based product.

In some preferred embodiments of the invention, the high-protein dairy-based product comprises a carbohydrate-based stabilizer. In a preferred embodiment, the carbohydrate-based stabilizer is a hydrocolloid. The carbohydrate-based stabilizer can be selected from the group of xanthan, guar gum, locust bean gum, gum karaya, gum tragacanth, gum Arabic, alginate, pectin, carrageenan, gelatin, gellan and agar. However, in other preferred embodiments of the invention the high protein dairy-based product does not contain carbohydrate-based stabilizer.

In some preferred embodiments of the invention, the high-protein dairy-based product comprises one or more of non-carbohydrate natural or artificial sweeteners.

For example, the high-protein dairy-based product may comprises one or more natural sweetening agent(s) that are not sugars. These natural sweetening agent(s) may be provided as a component of a second sweetening agent, either alone, or in combination with a carbohydrate sweetener, as described. The natural non-carbohydrate sweetening agent(s) may for example be selected from the group consisting of Momordica Grosvenorii (Mogrosides IV or V) extracts, Rooibos extracts, Honeybush extracts, Stevia extract, Rebaudioside A, thaumatin, Brazzein, Glycyrrhyzic acid and its salts, Curculin, Monellin, Phylloducin, Rubusosides, Mabinlin, dulcoside A, dulcoside B, siamenoside, monatin and its salts (monatin SS, RR, RS, SR), hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, cyclocarioside I, erythritol, isomaltulose and/or natural polyols such as maltitol, mannitol, lactitol, sorbitol, inositol, xylitol, threitol, galactitol and combinations thereof.

If used, the total amount of natural sweetener of the high-protein dairy-based product is typically in the range of 0.5-10% w/w, such as for example, in the range of 1-10% w/w. Alternatively, the total amount of natural sweetener may be in the range of 5-10% w/w.

Alternatively, or additionally, the high-protein dairy-based product may comprises one or more artificial sweetening agent(s). These artificial sweetening agent(s) may be provided as a component of the first sweetener, either alone or in combination with other of the sweeteners as defined above. The artificial non-carbohydrate sweetening agent(s) may for example be selected from the group consisting of Aspartame, Cyclamate, Sucralose, Acesulfame K, neotame, Saccharin, Neohesperidin dihydrochalcone, Stevia extract, Rebaudioside A, thaumatin, Brazzein, Glycyrrhyzic acid and its salts, Curculin, Monellin, Phylloducin, Rubusosides, Mabinlin, dulcoside A, dulcoside B, siamenoside, monatin and its salts (monatin SS, RR, RS, SR) and combinations thereof.

If used, the total amount of artificial sweetening agent(s) of the high-protein dairy-based product is typically in the range of 0.1-1% w/w, such as in the range of 0.1-0.5% w/w. Alternatively, the total amount of artificial sweetener may be in the range of 0.2-0.5% w/w.

In some embodiments of the invention, it is particularly preferred that the sweetener comprises or even consists of one or more high-intensity sweeteners (HIS). HIS are both found among the natural and artificial sweeteners and typically have a sweetening intensity of at least 10 times that of sucrose. Non-limiting examples of useful HIS are Aspartame, Cyclamate, Sucralose, Acesulfame K, neotame, Saccharin, Neohesperidin dihydrochalcone and combinations thereof.

In the context of the present invention, the term “high-intensity sweetener” pertains to a sweetener which provides a sweetness intensity (tested in water at 25 degrees C.) per g that is at least 10 times higher than that the sweetness intensity provided by sucrose.

If used, the total amount of HIS of the high-protein dairy-based product is typically in the range of 0.01-2% w/w. For example, the total amount of HIS may be in the range of 0.05-1.5% w/w. Alternatively, the total amount of HIS may be in the range of 0.1-1.0% w/w.

It may furthermore be preferred that the sweetener comprises or even consists of one or more polyol sweetener(s). Non-limiting examples of useful polyol sweetener are maltitol, mannitol, lactitol, sorbitol, inositol, xylitol, threitol, galactitol or combinations thereof.

If used, the total amount of polyol sweetener of the high-protein dairy-based product is typically in the range of 1-20% w/w. For example, the total amount of polyol sweetener may be in the range of 2-15% w/w. Alternatively, the total amount of polyol sweetener may be in the range of 4-10% w/w.

In a preferred embodiment of the invention, the dairy-based product does not comprise noncarbohydrate natural or artificial sweetener.

In some preferred embodiments of the invention, the high-protein dairy-based product furthermore comprises one or more vitamin(s), such as e.g. vitamin A, vitamin D, vitamin E, vitamin K, thiamine, riboflavin, pyridoxine, vitamin B12, niacin, folic acid, pantothenic acid, biotin, vitamin C, choline, vitamin B8, their salts, their derivatives and combinations thereof.

The content of the one of more vitamins of the high-protein dairy-based product may e.g. be in the range of 0.01-1% w/w based on the weight of the dairy-based product, preferably in the range of 0.1 to 0.5% w/w.

In some preferred embodiments of the invention, the vitamin comprises or even consists essentially of vitamin D.

In some preferred embodiments, the dairy-based product comprises vitamin D in an amount within the range of 0.5-2.5 microgram/100 ml, more preferably, the dairy-based product comprises vitamin D in an amount within the range of 1.0-1.5 microgram/100 ml. Even more preferably, the dairy-based product comprises vitamin D in an amount within the range of 1.1-1.3 microgram/100 ml, more preferably, the dairy-based product comprises vitamin D in an amount within the range of 1.15-1.25 microgram/100 ml. In a preferred embodiment, the dairy-based product comprises vitamin D in an amount of 1.2 microgram/100 ml.

In some embodiments of the invention, the dairy-based product comprises both vitamin D and vitamin K.

The high-protein dairy-based product can be shaped to any shape and combined with at least one further ingredient. Preferably, the dairy-based product is shaped to form a bar or to bitesized pieces. The high-protein dairy-based product obtained from step b) is preferably and extruded bar.

In an aspect of the invention, the invention pertains to a method for producing a food product comprising the steps of:
a) providing a dairy-based product according to the invention;
b) combining the dairy-based product with at least one further ingredient to obtain the food product; and
c) optionally, packaging the food product.

The food product obtainable by the method for producing a food product comprises the dairy-based product and at least one further ingredient.

In a preferred embodiment, the food product may be selected from the group consisting of a yoghurt bar, bite-sized pieces, a dessert, a cake, a sports bar and a protein bar.

In a preferred embodiment, the invention pertains to a method for producing a yoghurt bar comprising the steps of:
a) providing a dairy-based product according to the invention, which dairy-based product is in the form of a bar;
b) combining the dairy-based product with at least one further ingredient to obtain the food product; and
c) optionally, packaging the food product.

In a preferred embodiment of the invention, the further ingredient is used for coating the dairy-based product. The coating may have a base selected from chocolate, cocoa, fruit and/or sugar.

One example of a coating is a chocolate coating having a high content of chocolate. The coating may also be a low-grade chocolate coating, e.g. a coating based on sugar, vegetable fat and cocoa. In a preferred embodiment, the food product is a dairy-based product bar coated with a chocolate based coating. In an even more preferred embodiment, the food product is a yoghurt bar coated with a chocolate based coating.

In a preferred embodiment, the invention pertains to a method for producing a yoghurt bar comprising the steps of:
a) providing a dairy-based product according to the invention, which dairy-based product is in the form of a bar;
b) combining the dairy-based product with at least one further ingredient to obtain the food product; and
c) optionally, packaging the food product;
   wherein the further ingredient is a coating based on chocolate, cocoa, fruit and/or sugar.

In one embodiment, the further ingredient may be mixed with the dairy-based product. The further ingredient can be based on chocolate, cocoa, fruit and/or sugar, or the ingredient can be a baked product.

In one embodiment of the invention, the dairy-based product is combined with a baked product, e.g. by contacting one or more surfaces of the dairy-based product with the baked product.

The baked product can be a waffle, a cookie, a biscuit or pastry. In a preferred embodiment, the dairy-based product is in the form of a bar and is placed on a baked product to form a bar comprising the dairy-based product and a baked product. In a more preferred embodiment the dairy-based product is a bar, placed on a baked product and coated with a chocolate-based coating. Even more preferred is a yoghurt bar with a basis of baked product and coated with chocolate.

The dairy-based product according to the invention and the food product according to the invention has a high content of protein and can be used for increasing intake of protein.

In a preferred embodiment, the invention pertains to a food product having a core of a high-protein dairy-based product having a protein content in the range of 14-40% w/w, a dry-matter content in the range of 40-60% w/w, a pH of 3.5-6.0 and comprising Greek yoghurt, and at least 8% w/w of acid-gellable whey protein aggregates, cream, sucrose, inulin, and optionally, at least one further ingredient, and a coating comprising chocolate, cocoa, fruit and/or sugar.

In a preferred embodiment, the invention pertains to a food product having a core of a high-protein dairy-based product having a protein content in the range of 16-36% w/w, a dry-matter content in the range of 45-60% w/w, a pH of 3.5-6.0 and comprising Greek yoghurt, and at least 8% w/w of acid-gellable whey protein aggregates, cream, sucrose, inulin, and optionally, at least one further ingredient, and a coating comprising chocolate, cocoa, fruit and/or sugar.

In a preferred embodiment, the invention pertains to a food product having a core of a high-protein dairy-based product having a protein content in the range of 18-34% w/w, a dry-matter content in the range of 50-60% w/w, a pH of 3.5-6.0 and comprising Greek yoghurt, and at least 8% w/w of acid-gellable whey protein aggregates, cream, sucrose, inulin, and optionally, at least one further ingredient, and a coating comprising chocolate, cocoa, fruit and/or sugar.

In a preferred embodiment, the invention pertains to a food product having a core of a high-protein dairy-based product having a protein content in the range of 20-30% w/w, a dry-matter content in the range of 55-60% w/w, a pH of 3.5-6.0 and comprising Greek yoghurt, and at least 8% w/w of acid-gellable whey protein aggregates, cream, sucrose, inulin, and optionally, at least one further ingredient, and a coating comprising chocolate, cocoa, fruit and/or sugar.

The invention is further summarized in the following embodiments.
1. A method for preparing a high-protein, dairy-based product having a protein content of at least 14% w/w and a dry-matter content of at least 40% w/w, the method comprising
   a) combining an acidified dairy product, acid-gellable whey protein aggregates and optionally, at least one further ingredient to obtain a mixture;
   b) optionally, shaping and/or packaging the mixture, and
wherein the high-protein dairy-based product is the mixture obtained from step a) and/or step b).
2. The method according to embodiment 1, wherein the high-protein dairy-based product is self-supporting.
3. The method according to any of the preceding embodiments, wherein the mixture has a texture of at least 20.000 g·sec.
4. The method according to any of the preceding embodiments, wherein the dairy-based product has a protein content of at least 16% w/w, preferably at least 18% w/w, more preferably at least 18% w/w, even more preferably at least 20% w/w and most preferred at least 21% w/w.
5. The method according to any of the preceding embodiments, wherein the dairy-based product has a dry-matter content of at least 45% w/w, preferably at least 50% w/w and more preferably at least 55% w/w.
6. The method according to any of the preceding embodiments, wherein the dairy-based product has a dry-matter content in the range of 40-60% w/w, preferably in the range of 45-60% w/w, more preferably in the range of 50-60% w/w or in the range of 55-60% w/w.
7. The method according to any of the preceding embodiments, wherein the acidified dairy product has a fat content in the range of 0.5 to 30% w/w.
8. The method according to embodiment 7, wherein the acidified dairy product has a fat content in the range of 0.5 to 12% w/w, preferably in the range of 1-11% w/w or in the range of 2-10% w/w.
9. The method according to embodiment 7, wherein the acidified dairy product has a fat content in the range of 20-30% w/w, preferably in the range of 22-28% w/w or in the range of 24-26% w/w.
10. The method according to any of the preceding embodiments, wherein the acidified dairy product has a dry-matter content in the range of 15-55% w/w.
11. The method according to embodiment 10, wherein the acidified dairy product has a dry-matter content in the range of 15-25% w/w, preferably in the range of 18-20% w/w.
12. The method according to embodiment 10, wherein the acidified dairy product has a dry-matter content in the range of 45-55% w/w, preferably in the range of 48-52% w/w.
13. The method according to any of the preceding embodiments, wherein the acidified dairy product has a protein content in the range of 3-20% w/w, preferably in the range of 4-8% w/w or in the range of 9-15% w/w.
14. The method according to any of the preceding embodiments, wherein the acidified dairy product is a strained yoghurt, a stirred yoghurt, a cream cheese or a mixture thereof.
15. The method according to embodiment 14, wherein the acidified dairy product is selected from the group of Greek yoghurt, skyr, quark and cream cheese.
16. The method according any of the preceding embodiments, wherein the acid-gellable whey protein aggregates constitute at least 8% w/w based on the total weight of the dairy-based product.
17. The method according to any of the preceding embodiments, wherein the acid-gellable whey protein aggregates constitute in the range of 8-20% w/w of acid-gellable whey protein aggregates based on the total weight of the dairy-based product, preferably in the range of 9-18% w/w, in the range of 10-16% w/w or in the range of 12-14% w/w.
18. The method according to any of the preceding embodiments, wherein the acid-gellable whey protein aggregates constitute at least 40% w/w of the total protein in the dairy-based product, preferably at least 50%, more preferably at least 55% w/w, even more preferably at least 60% w/w or at least 65% w/w of the total protein in the dairy-based product.
19. The method according to any of the preceding embodiments, wherein the acid-gellable whey protein aggregates constitute in the range of 40-70% w/w of the total protein in the dairy-based product, preferably in the range of 45-68% w/w, in the range of 50-68% w/w, in the range of 55-68 or in the range of 60-68% w/w.
20. The method according to any of the preceding embodiments, wherein the acid-gellable whey protein aggregates constitute at least 10% w/w based on the total weight of the dairy-based product, preferably at least 12% w/w based on the total weight of the dairy-based product or at least 14% w/w based on the total weight of the dairy-based product.
21. The method according to any of the preceding embodiments, wherein the acid-gellable whey protein aggregates constitute in the range of 10-20% w/w based on the total weight of the dairy-based product, preferably in the range of 12-18% w/w or more preferred in the range of 14-16% w/w.
22. The method according to any of the preceding embodiments, wherein the acid-gellable whey protein aggregates constitute at least 15% w/w based on the dry-matter content of the dairy-based product, preferably in the range of 18-16% w/w or more preferred in the range of 20-24% w/w.
23. The method according to any of the preceding embodiments, wherein the acid-gellable whey protein aggregates constitute in the range of 15-30% w/w based on the dry-matter content of the dairy-based product, preferably in the range of 18-16% w/w or more preferred in the range of 20-24% w/w.
24. The method according to any of the preceding embodiments, wherein the pH of the mixture is adjusted to a pH of less than 6.0, preferably below 5.5, more preferred below 5.0 or even more preferred below 4.5.
25. The method according to any of the preceding embodiments, wherein the pH of the mixture has a pH within the range of 3.5-6.0, preferably in the range of 4.0-5.5, in the range of 4.0-5.0 or in the range of 4.2-4.5.
26. The method according to any of the preceding embodiments, wherein the method is carried out at a temperature below 20 degrees C., preferably at a temperature below 15 degrees C., more preferably at a temperature below 10 degrees C.
27. The method according to any of the preceding embodiments, wherein the method is carried out at a temperature in the range of 0-20 degrees C., preferably in the range of 0-15 degrees C., more preferably in the range of 5-15 degrees C. or even more preferred at a temperature of 10 degrees C.
28. The method according to any of embodiments 1-25, wherein the mixture is heated to a temperature of at least 70 degrees C. for a duration of time sufficient to obtain at least partial microbial reduction, such as to a temperature of at least 72 degrees C. for a duration sufficient to obtain at least a 5-log₁₀ reduction of viable Escherichia coli, preferably for at least 15 seconds.
29. The method according to any of the preceding embodiments, wherein the mixture is cooled to a temperature below 20 degrees C., preferably at a temperature below 15 degrees C., more preferably at a temperature below 10 degrees C. or even more preferred at a temperature below 5 degrees C.
30. The method according to any of the preceding embodiments, wherein the mixture is cooled to a temperature in the range of 0-20 degrees C., preferably in the range of 0-15 degrees C., more preferably in the range of 0-10 degrees C. or even more preferred at a temperature of 5 degrees C.
31. The method according to any of the previous embodiments, wherein the further ingredient is selected from fats, carbohydrates, vitamins, sweeteners, carbohydrate-based stabilizers and mixtures thereof.
32. The method according to any of the preceding embodiments, wherein the further ingredient is fat selected from dairy-based fat or vegetable fat.
33. The method according to embodiment 32, wherein the dairy fat is selected from one or more of cream, acidified cream and/or butter.
34. The method according to embodiment 32, wherein the vegetable fat is selected from the group consisting of maize oil, sesame oil, soya oil, soya bean oil, linseed oil, grape seed oil, rapeseed oil, olive oil, groundnut oil, sunflower oil, safflower oil, palm fat, palm kernel fat and cocoanut fat and a combination thereof.
35. The method according to any of the preceding embodiments, wherein the further ingredient is carbohydrate selected from monosaccharide, disaccharide and/or polysaccharide.
36. The method according to embodiment 31, wherein the carbohydrate is selected from sucrose, maltose, lactose, dextrose, glucose, fructose, galactose or a combination thereof.
37. The method according to embodiment 31, wherein the carbohydrate is dietary fibre, preferably selected from fructose oligosaccharide and/or galactose oligosaccharide, preferably inulin.
38. The method according to embodiment 31, wherein the carbohydrate is a carbohydrate based stabilizer, preferably a hydrocolloid.
39. The method according to any of the preceding embodiments, wherein the further ingredient is a sweetener selected from carbohydrate sweeteners or non-carbohydrate sweeteners.
40. The method according to any of the preceding embodiments, wherein the further ingredient is a vitamin selected from vitamin A, vitamin D, vitamin E, vitamin K, thiamine, riboflavin, pyridoxine, vitamin B12, niacin, folic acid, pantothenic acid, biotin, vitamin C, choline, vitamin B8, their salts, their derivatives and combinations thereof.
41. The method according to any of the preceding embodiments, wherein all further ingredients are dairy-based ingredients.
42. The method according to any of the preceding embodiments, wherein the mixture is stored at a temperature of 0-10 degrees C. for a period of 1-24 hours, preferably at a temperature of 0-5 degrees C. for a period of 1-24 hours or more preferably at a temperature of 0-5 degrees C. for a period of 5-16 hours.
43. The method according to any of the preceding embodiments, wherein the mixture is shaped by extrusion, moulding and/or by filling in a container.
44. The method according to any of the preceding embodiments, wherein the dairy-based product is packaged in any useful package or container.
45. A high-protein dairy-based product obtainable by the method of any of embodiments 1-44, wherein the texture of the composition is at least 20.000 g·sec.
46. The dairy-based product according to embodiment 45, wherein the texture of the composition is at least 25.000 g·sec, preferably at least 30.000 g·sec, more preferably at least 35.000 g·sec, even more preferably at least 35.000 g·sec or most preferred at least 40.000 g·sec.
47. The dairy-based product according to any of embodiments 45-46, wherein the texture of the dairy-based product is in the range of 20.000-60.000 g·sec, preferably in the range of 25.000-60.000 g·sec, more preferably in the range of 30.000-60.000 g·sec, even more preferably in the range of 35.000-60.000 g·sec, or most preferred in the range of 40.000-60.000 g·sec.
48. The dairy-based product according to any of embodiments 45-47, wherein the product comprises viable lactic acid bacteria.
49. The dairy-based product according to embodiment 48, wherein the product comprises at least 2.5 million viable lactic acid bacteria per gram of the product, preferably at least 3.0 million viable lactic acid bacteria per gram of the product.
50. The dairy-based product according to any of embodiments 48-49, wherein the lactic acid bacteria comprises lactic acid bacteria selected from Lactobacillus Acidophilus, Streptococcus thermophiles and Lactobacillus delbrueckii subsp. Bulgaricus.
51. The dairy-based product according to any of embodiments 45-50, wherein the protein contributes to the nutritional value with at least 18 E %, preferably at least 20 E %, more preferably at least 23 E %, even more preferably at least 28 E % and most preferred at least 30 E %.
52. The dairy-based product according to any of embodiments 45-51, wherein the nutritional value of the composition is in the range of 20-40 E % protein, 30-45 E % fat and 25-35 E % carbohydrate, preferably in the range of 28-35 E % protein, 30-40 E % fat and 28-35 E % carbohydrate.
53. Method for producing a food product comprising the steps of:
   a) providing a dairy-based product according to any of embodiments 45-52;
   b) combining the dairy-based product with at least one further ingredient to obtain the food product; and
   c) optionally, packaging the food product.
54. The method according to embodiment 53, wherein the dairy-based product is coated with the further ingredient, preferably by coating the dairy-based product with a coating having a base selected from chocolate, cocoa, fruit and/or sugar.
55. The method according to any of embodiments 53-54, wherein the dairy-based product is mixed with the further ingredient.
56. The method according to any of embodiments 53-55, wherein the dairy-based product is combined with a baked product.
57. Food product obtainable by the method of embodiments 43-56, comprising the dairy-based product and at least one further ingredient.
58. Food product according to embodiment 57, wherein the product is selected from the group consisting of a yoghurt bar, a dessert, a cake, a sports bar and a protein bar.
59. Food product according to any of embodiments 57-58, wherein the product is coated with a chocolate coating.
60. Use of the high-protein dairy-based product according to any of embodiments 45-52 or the food product according to any of embodiments 57-59 for increasing the intake of protein.

### EXAMPLES

### Example 1.1: Quantification of Acid-Gellable Whey Protein Aggregates (aqWPA)

The amount of acid-gellable whey protein aggregates is determined using the following procedure.

Procedure:

1. Dissolve a sample of approx. 1.00 g powder in phosphate buffer to obtain 1000 mL. If the sample is in the form of a liquid, then a liquid sample containing approx. 1.00 g dry matter is diluted to 1000 mL with phosphate buffer (0.02M NaH₂PO₄ pH 7.5). Write down the precise dilution factor (typically close to 1000). Allow the dissolved (or diluted) sample to stand for 24 hours before proceeding to step 2.

2. Determine the amount of total protein (true protein) of the dissolved sample as described in example 1.4. The amount of total protein of the dissolved sample is referred to as “X” (% (w/w) total protein relative to total weight of the dissolved sample).

3. Centrifuge 100 mL of the dissolved sample at 62000 g for 30 minutes. The centrifugation is performed at approx. 15 degrees C. using a refrigerated centrifuge 3-30K from SIGMA Laborzentrifugen GmbH and 85 mL tubes (Order no. 15076) or similar equipment.

4. Collect the resulting supernatant and filter it through a 0.22 micron filter to remove traces of microparticles that could damage the HPLC-column of the following HLPC analysis.

5. Determine the total protein (true protein) of the filtered supernatant by using the procedure disclosed in Example 1.4. The amount of total protein of the filtered supernatant is referred to as “Y” (% (w/w) total protein relative to total weight of the filtered supernatant).

6. Quantify the amount (% (w/w) relative to total weight of the filtered supernatant) of native alpha-lactalbumin, beta-lactoglobulin, and caseinomacropeptide using the procedure described in Example 1.2.

7. Calculate the relative amount of acid-gellable whey protein aggregates (% (w/w) acid-gellable aggregates relative to total amount of protein of the original sample). This can be done using the formula:

Z_{Relative amount of acid-gellable aggregates}=((Y−Cₐₗₚₕₐ−C_{beta}−C_{CMP})/X)*100% (w/w total protein of the original sample)

The absolute amount of acid-gellable whey protein aggregates of the original sample is calculated by multiplying the relative amount of acid-gellable whey protein aggregates with X* dilution factor (going from 1 g sample to 1000 mL (=approx. 1000 g) dissolved sample gives a dilution factor of 1000). The formula looks like this:

Absolute amount of acid-gellable whey protein aggregates of the original sample=Z_{Relative amount of acid-gellable whey protein aggregates}*X*dilution factor

### Example 1.2: Determination of Texture

The texture of high-protein acidified products can be characterised by a compression measurement. With this method, the high-protein acidified products are measured on a Texture Analyser that is driven 30 mm into the high-protein acidified product with a speed of 0.5 mm/s. For most food systems, the texture is very dependent on the temperature, why the described method is performed taking samples directly from a controlled temperature cabinet. The result of the measurement is presented in g*sec (force area) shown as an average area value 30 mm into the high-protein acidified product.

A higher texture corresponds to a more compact material.

Procedure:

1. Sample Preparation

Each sample is tapped into 5 cups during the processing and stored for 2 days in a cool storage (4° C.). The cups are placed in the laboratory cooler (5° C.) to temper for 1 day.

2. Setup

Set up the program as described in method setup. Install the 5 kg load cell, probe and the cup holder plate. Before the first measurement, the force and height are calibrated, the force is eventually calibrated with a 2 kg weight if needed.

3. Measuring

Each cup is taken out from the laboratory cooler (5° C.) one by one and placed in the cup holder centred under the probe. The measurement is carried out.

4. Cleaning

The probe is wiped clean with laboratory tissues between the measurements. Results: The result of the measurement is given in g*sec (force area) shown as an average area value 30 mm into the yoghurt. 95% confidence interval is calculated and the results are illustrated in a graph with the 95% confidence intervals.

Materials:

For this procedure, the following are needed:
Texture Analyser TA XTPlus, Stable Micro Systems
Interchangeable 5 KG load cell, Stable Micro Systems.
P/35 Alu probe, Stable Micro Systems
2 kg calibration weight (handled with gloves only)
Cup holder plate.
Sample cup dimensions 65 mm (height)×65 mm (diameter top)×55 mm (diameter bottom); 155 ml (volume)

### Example 1.3: Determination of Total Protein

The total protein content (true protein) of a sample is determined by:

1) Determining the total nitrogen of the sample following ISO 8968-1/2|IDF 020-1/2—Milk—Determination of nitrogen content—Part 1/2: Determination of nitrogen content using the Kjeldahl method.

2) Determining the non-protein nitrogen of the sample following ISO 8968-4|IDF 020-4—Milk—Determination of nitrogen content—Part 4: Determination of non-protein-nitrogen content.

3) Calculating the total amount protein as (m_{total nitrogen}−m_{non-protein-nitrogen})*6.38.

### Example 1.4: Determination of the Water Content of a Powder

The water content of a food product is determined according to ISO 5537:2004 (Dried milk —Determination of moisture content (Reference method)). NMKL is an abbreviation for “Nordisk Metodikkomite for Naringsmidler”.

### Example 1.5: Determination of Ash Content

The ash content of a food product is determined according to NMKL 173:2005 “Ash, gravimetric determination in foods”.

### Example 1.6: Determination of the Total Solids of a Solution

The total solids of a solution may be determined according NMKL 110 2^{nd} Edition, 2005 (Total solids (Water)—Gravimetric determination in milk and milk products). NMKL is an abbreviation for “Nordisk Metodikkomite for Naringsmidler”.

The water content of the solution can be calculated as 100% minus the relative amount of total solids (% w/w).

### Example 1.7: Determination of the Total Amount of Lactose

The total amount of lactose is determined according to ISO 5765-2:2002 (IDF 79-2: 2002) “Dried milk, dried ice-mixes and processed cheese—Determination of lactose content—Part 2: Enzymatic method utilizing the galactose moiety of the lactose”.

### Example 1.8: Determination of the Degree of Denaturation

The denaturation degree of the proteins of the denatured whey protein compositions was analyzed by size exclusion high-performance liquid chromatography (SE-HPLC). A Waters 600 E Multisolvent Delivery System, a Waters 700 Satellite Wisp Injector, and a Waters H90 Pro grammable Multiwavelength Detector (Waters, Milford, MA, USA) were used. The elution buffer was composed of 0.15 M Na2SO4, 0.09 M KH2PO₄ and 0.01 M K2HPO4. The flow rate was 0.8 mL min-1 and the temperature 20° C.

Twenty-four hours prior to analysis, suspensions of the denatured whey protein compositions were prepared by using a sodium phosphate buffer (0.02 M) to obtain a final protein content of 0.1% (w/v). In addition, standard solutions of alpha-lactalbumin (Sigma-Aldrich Chemie GmbH, Steinheim, Germany) and beta-lactoglobulin (Sigma-Aldrich Chemie GmbH), and caseinomacropeptide at a concentration of 1 mg mL-1 were prepared. Prior to injection, the solutions were stirred and filtered (0.22 micron). A 25 microL sample was injected. The absorbance was recorded at 210 and 280 nm. For all the samples of denatured whey protein compositions and standards, the total protein content was determined according to Example 1.4.

A quantitative analysis of the native whey protein content was performed by comparing the peak areas obtained for the corresponding standard proteins with those of the samples. Afterwards, the denatured whey protein content of the denatured whey protein compositions was calculated by considering the total protein content of the samples and their quantified native protein. The degree of denaturation was calculated as (w_{total protein}−w_{solutble protein})/w_{total protein}*100%, wherein w_{total protein} is the weight of total protein and w_{solutble protein} is the weight of soluble protein.

### Example 1.9: Determination of the Total Amounts of Calcium, Magnesium, Sodium, and Potassium

The total amount of calcium, magnesium, sodium, and potassium cations are determined using a procedure in which the samples are first decomposed using microwave digestion and then the total amount of mineral(s) is determined using an ICP apparatus.

Apparatus:

The microwave is from Anton Paar and the ICP is an Optima 2000DV from PerkinElmer Inc.

Materials:

1 M HNO₃

Yttrium in 2% HNO₃

Suitable standards for calcium, magnesium, sodium, and potassium in 5% HNO₃

Pre-Treatment:

Weigh out a certain amount of powder and transfer the powder to a microwave digestion tube.

Add 5 mL 1M HNO₃. Digest the samples in the microwave in accordance with microwave instructions.

Place the digested tubes in a fume cupboard, remove the lid and let volatile fumes evaporate.

Measurement Procedure:

Transfer the pre-treated sample to the digitube using a known amount of Milli-Q water. Add a solution of yttrium in 2% HNO₃ to the digestion tube (about 0.25 mL per 50 mL diluted sample) and dilute to known volume using Milli-Q water. Analyze the samples on the ICP using the procedure described by the manufacturer.

A blind sample is prepared by diluting a mixture of 10 mL 1M HNO₃ and 0.5 mL solution of yttrium in 2% HNO₃ to a final volume of 100 mL using Milli-Q water.

At least 3 standard samples are prepared having concentrations which bracket the expected sample concentrations.

### Example 1.10: Determination of pH

All pH values are measured using a pH glass electrode and are normalised to 25 degrees C. The pH glass electrode (having temperature compensation) is rinsed carefully before and calibrated before use.

When the sample is in liquid form, pH is measured directly in the liquid solution at 25 degrees C.

When the sample is a powder, 10 grams of a powder is dissolved in 90 ml of demineralised water at room temperature while stirring vigorously. The pH of the solution is then measured at 25 degrees C.

### Example 1.11: Sensory Evaluation

This sensory evaluation is used as a method to describe and compare a group of formulas. The results are relative. The sensory panel are technical personnel who are trained to evaluate fresh dairy products. The panel is usually 3-5 persons. There are no reference samples to determine the level between 0 and 10 on the scale, so the evaluation is based on experience, knowing the average grades for the type of product.

Example: The sample with the highest relative mouthfeel in the group of formula is not graded 10, but often given a grade according to what is normal for this type of product.

Products can be evaluated sensorially by a trained sensory test panel consisting. The product were evaluated and ranked by the following characteristics:

| Category | Descriptors |
|---|---|
| Syneresis | If there is no visible syneresis the sample is graded with a 0. The higher the |
| | syneresis, the higher grade on the scale. The scale is available from 0 to 10. |
| Spoon | A spoonful of the sample is placed on the surface of the product. This |
| viscosity | procedure is done for each sample in the evaluation before the samples are |
| | graded. The spoon viscosity is evaluated based on the product's ability to |
| | “flow” and if the spoonful of sample keeps its shape. The higher the viscosity, |
| | the higher grade on the scale. The scale is available from 0 to 10. |
| Shininess | The sample is evaluated for shininess by looking at a thin layer of the product |
| | on the back of the spoon. If the sample is homogeneous without gel |
| | lumps or white spots, it is graded higher compared to a sample with gel |
| | lumps or white spots. The scale is available from 0 to 10. |
| Smoothness | By tasting the sample, it is evaluated how smooth the sample is perceived. If |
| | the sample has a high smooth feeling in the mouth, it is graded higher |
| | compared to samples having a less smooth perception. A grainy sensation is |
| | evaluated lower than a dry sensation. The scale is available from 0 to 10. |
| Dryness | By tasting, the sample is evaluated for dryness. If there is any dry sensation |
| | in the yoghurt, the dryness is evaluated regarding to the ranking no dryness, |
| | dry, floury, sandy, or grainy. The scale is available from 0 to 10. |
| Mouth feel | By tasting, the samples ability to “flow” and disappear in the mouth is |
| | evaluated. If the sample has a high mouthfeel it is graded higher. The scale is |
| | available from 0 to 10. |
| Off-taste | If there is a distinctive off-taste the sample is graded 1, and the off-taste is |
| 0 = No | described. If there is none off-taste found the sample is graded 0. |
| 1 = Yes | |

If more than one sample is evaluated, the samples are compared and ranked according to the parameters evaluated. Samples are allowed to score equally in the evaluation.

The first evaluation is conducted within the first week after production and thereafter once a week, if requested.

### Example 1.12: Determination of the Number of Coloni-Forminq Units

Interest in the presence of live bacteria during shelf life is evaluated alongside with the absence of the most known contaminating microorganisms within food spoilage.

The determination of the number of Lactobacillus bulgaricus is performed according to ISO 7889:2003, the determination of the number of Streptococcus thermophlus is performed according to ISO 7889:2003, and the determination of Lactobacillus acidophilus is determined according to FVST 08:2007.

The determination of content of Bacillus cereus were performed according to ISO 7932:2005, Listeria monocytogenes were performed according to NordVal 022, Salmonella were performed according to ISO 6785, thermo tolerante Campylobacter were performed according to NMKL 199:2007, Clostridium perfringens were performed according to NMKL 95:2009-M, and coagulase positive staphylococci were performed according to UM1M2, an internal Eurofins Steins Laboratorium method. All determinations of microbial species are conducted at Eurofins Steins Laboratorium A/S.

### Example 2: Preparing a Dairy-Based Product from Different Protein Sources Including agWPA

The present example prepares yoghurt bars (dairy-based product) from Greek yoghurt 108 and different protein sources. A dairy-based product is prepared from Greek yoghurt 10%/ and acid-gellable whey protein aggregates (agWPA). For comparison, dairy-based products are prepared from Greek yoghurt 10 and a protein source from MPC (milk protein powder), WPC80 (whey protein powder, total protein 80 w/w), caseinate and Variolac® 836. The dairy-based products are prepared with and without adjusting the pH of the composition. The pH is measured as outlined in example 1.10. The compositions are evaluated sensorially, microbially and with regard to texture as described in examples 1.11, 1.12 and 1.2.

| | Dairy-based product | | | | | | | |
|---|---|---|---|---|---|---|---|---|
| | Composition number: | | | | | | | |
| Ingredient % w/w | 1 | 2 | 3 | 4 | 5 | 6 | 7 | 8 |
| Yoghurt, Kløver Greek inspired: | 47 | 43.4 | 46.4 | 43.5 | 47 | 43.4 | 46.4 | 43.5 |
| 10% fat, 4.2% protein | | | | | | | | |
| and total solids of 19% | | | | | | | | |
| Cream, 38% fat, 2.1% protein | 9 | 13 | 10 | 13.7 | 9 | 13 | 10 | 13.7 |
| and total solids of 44% | | | | | | | | |
| Whey powder comprising approx. | 38 | 0 | 0 | 0 | 38 | 0 | 0 | 0 |
| 75% agWPA relative to | | | | | | | | |
| total protein and approx. 50% | | | | | | | | |
| protein relative to the weight of | | | | | | | | |
| the powder | | | | | | | | |
| Milk protein Concentrate (MPC) | 0 | 23.6 | 0 | 0 | 0 | 23.6 | 0 | 0 |
| Fromaquick A (86/5) [A.A] | | | | | | | | |
| Whey protein concentrate 80 | 0 | 0 | 24.3 | 0 | 0 | 0 | 24.3 | 0 |
| (WPC 80) GermanProt 8000 | | | | | | | | |
| Sachsenmilch | | | | | | | | |
| Caseinate, Na, Miprodan ® 30 | 0 | 0 | 0 | 20.8 | 0 | 0 | 0 | 20.8 |
| Permeate, Variolac ® 836 | 0 | 14 | 13.3 | 16 | 0 | 14 | 13.3 | 16 |
| Sugar, sucrose, white | 6 | 6 | 6 | 6 | 6 | 6 | 6 | 6 |
| Sum of ingredients | 100 | 100 | 100 | 100 | 100 | 100 | 100 | 100 |

The dairy-based products were prepared by adding all the ingredients into the bowl of a Hobart mixer. The ingredients were mixed for 1 minute at 107 RPM, 30 seconds at 198 RPM and 30 seconds at 361 RPM. The bowl was scraped. For compositions 1-4, the pH was adjusted with lactic acid to a pH of about 4.35. The composition was then mixed for 30 seconds at 361 RPM. The compositions were then stored at 5 degree C. for about 16 hours before being extruded to form a bar shaped mass weighing around 50 grams and then subsequently coated with chocolate.

The pH of the compositions after the ingredients were mixed and after pH adjustment is shown in table 2:

| | 1 | 2 | 3 | 4 | 5 | 6 | 7 | 8 |
|---|---|---|---|---|---|---|---|---|
| After | 6.09 | 5.95 | 5.83 | 5.83 | 6.09 | 5.95 | 5.83 | 5.83 |
| mixing | | | | | | | | |
| After pH | 4.33 | 4.35 | 4.35 | 4.36 | — | — | — | — |
| adjust- | | | | | | | | |
| ment | | | | | | | | |

The content of nutrients and energy is shown in table 3:

| Nutrient | 1 | 2 | 3 | 4 | 5 | 6 | 7 | 8 |
|---|---|---|---|---|---|---|---|---|
| Protein % w/w | 21.7 | 21.7 | 21.7 | 21.7 | 21.7 | 21.7 | 21.7 | 21.7 |
| Fat % w/w | 9.8 | 9.8 | 9.8 | 9.7 | 9.8 | 9.8 | 9.8 | 9.7 |
| Carbohydrates % w/w | 20.3 | 20.2 | 20.4 | 21.3 | 20.3 | 20.2 | 20.4 | 21.3 |
| Total_Solids % w/w | 55.4 | 56.0 | 55.3 | 55.5 | 55.4 | 56.0 | 55.3 | 55.5 |
| Calcium % w/w | 0.2 | 0.6 | 0.3 | 0.2 | 0.2 | 0.6 | 0.3 | 0.2 |
| Energy_kJ/100 g | 1074.6 | 1072.9 | 1078.8 | 1091.7 | 1074.6 | 1072.9 | 1078.8 | 1091.7 |
| Energy_kcal/100 g | 255.7 | 255.3 | 256.7 | 259.7 | 255.7 | 255.3 | 256.7 | 259.7 |

The compositions were then evaluated sensorially by 4 trained test persons as described in example 1.11. Table 4 shows the result:

| | 1 | 2 | 3 | 4 | 5 | 6 | 7 | 8 |
|---|---|---|---|---|---|---|---|---|
| Syneresis | 0 | 0 | 0 | 4 | 0 | 0 | 0 | 0 |
| Spoon viscosity | 10 | 5 | 2 | 4 | 8 | 8 | 2 | 9 |
| Shininess | 2 | 6 | 10 | 6 | 2 | 2 | 10 | 3 |
| Mouthfeel | 9 | 6 | 4 | 5 | 7 | 6 | 5 | 7 |
| Smoothness | 8 | 3 | 8 | 1 | 7 | 5 | 9 | 5 |
| Dryness | 3 | 8 | 4 | 10 | 4 | 5 | 2 | 4 |
| Off-taste | 0 | 1 | 1 | 1 | 0 | 0 | 0 | 0 |
| 0 = No, 1 = Yes | | | | | | | | |

The sensorial analysis shows that the firmest structure of the composition is made using the whey powder comprising agWPA compared to MPC, WPC and caseinate. This is the case for both the adjusted pH (1-4) and the non-adjusted pH (5-8) compositions. The pH adjusted composition made with the whey powder comprising agWPA (1) has the highest spoon viscosity and mouthfeel and the lowest dryness score compared to all the other pH adjusted compositions made with either MPC (2) or WPC (3) or caseinate (4).

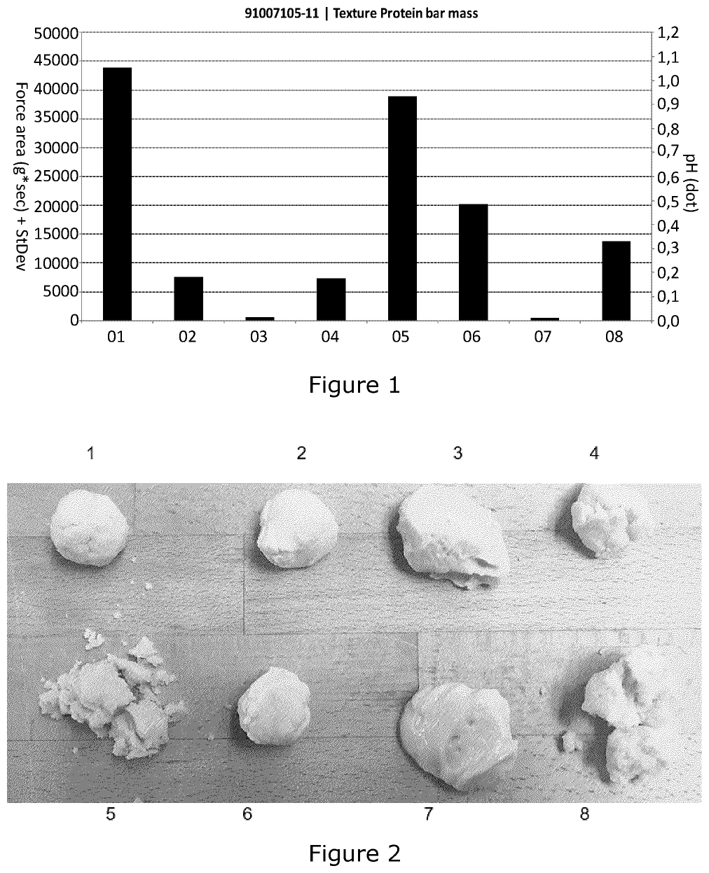

The compositions were evaluated with regard to texture. FIG. 1 shows that the firmest structure of the composition is made using whey powder comprising agWPA compared to MPC, WPC and caseinate. This is very dominant in the case for the adjusted pH compositions (1-4) but also very clear in the non-adjusted pH compositions (5-8).

FIG. 2 shows an attempt to make a round handmade ball where the same time and force is performed on the various compositions. The top four compositions (1-4) have been pH adjusted. The bottom four compositions (5-8) have not been pH adjusted. Looking at the pH adjusted compositions (1-4), the following is observed. A much firmer ball can be made using whey powder comprising agWPA (1) compared to MPC (2), WPC (3) and caseinate (4). The closest in firmness to composition No. 1 seems to be no. 4, but it is more brittle. Looking at the non-adjusted pH compositions (5-8), the following is observed. A crumble composition is made using whey powder comprising agWPA (5) similar to using caseinate (8). It is much easier to make the ball by using MPC (6), whereas using WPC (7) does not make a firm ball.

The yoghurt compositions no. 1 and no. 5 were analyzed with regard to microbiology as explained in example 1.12. The compositions were stored for 8 days at 5 degrees C. before being tested for number of colony-forming units (CFU) for the following microorganisms: Bacillus cereus, Listeria monocytogenes, Streptococcus thermophilus, Staphylococcus coagulase positive, Salmonella, Thermophilic Campholybacter, Lactobacillus acidophilus, Lactobacillus delbrueckii subsp. Bulgaricus and Clostridium perfringens.

In all compositions, the data show no presence of Listeria monocytogenes, Staphylococcus coagulase positive, Salmonella, Thermophilic Campholybacter and Clostridium perfringens. The count of Bacillus cereus were below 10 CFU/g.

For all the compositions the numbers of lactic acid bacteria were:
Streptococcus thermophilus: >3.000.000 CFU/g
Lactobacillus acidophilus: <10.000 CFU/g
Lactobacillus delbrueckii subsp. Bulgaricus: >140.000 CFU/g

### Example 3: Preparing a Dairy-Based Product from Greek Yoghurt 2% and agWPA—Yoghurt Bar

The present example prepares a yoghurt bar (dairy-based product) from Greek yoghurt 2% and different protein sources. A dairy-based product is prepared from Greek yoghurt 10% and acidgellable whey protein aggregates (agWPA). For comparison, dairy-based products are prepared from Greek yoghurt 2% and a protein source from MPC (milk protein powder), WPC80 (whey protein powder, total protein 80% w/w), caseinate and Variolac® 836. The pH of the dairy-based products are adjusted. The pH is measured as outlined in example 1.11 The composition is prepared from the ingredients shown in table 5:

| Ingredients % w/w | 1 | 2 | 3 | 4 |
|---|---|---|---|---|
| Yoghurt, Greek style Nostimo 2% fat, 8.5% | 37 | 37 | 37 | 37 |
| protein and total solids of 19% | | | | |
| Cream, 38% fat, 2.1% protein and total | 20 | 22 | 21 | 23 |
| solids of 44% | | | | |
| Whey powder comprising approx. 75% ag- | 34 | 0 | 0 | 0 |
| WPA relative to total protein and approx. | | | | |
| 50% protein relative to the weight of the | | | | |
| powder | | | | |
| MPC Fromaquick A (86/5) [A.A] | 0 | 21 | 0 | 0 |
| WPC 80 GermanProt 8000 Sachsenmilch | 0 | 0 | 21.7 | 0 |
| Caseinate, Na, Miprodan ® 30 | 0 | 0 | 0 | 18.5 |
| Permeate, Variolac ® 836 | 0 | 11 | 11.3 | 12.5 |
| Fibre, Inulin Orafti Synergy1 | 3 | 3 | 3 | 3 |
| Sugar, sucrose, white | 6 | 6 | 6 | 6 |

The dairy-based products are prepared by adding all the ingredients into the bowl of a Hobart mixer. The ingredients are mixed for 1 minute at 107 RPM, 30 seconds at 198 RPM and 30 seconds at 361 RPM. The bowl is scraped. The pH is adjusted with lactic acid to a pH of about 4.35. The composition is then mixed for 30 seconds at 361 RPM. The products are then stored at 5 degree C. for about 16 hours before being extruded to form a bar shaped mass weighing around 50 grams and then subsequently coated with chocolate.

The content of nutrients and energy are shown in table 6:

| Nutrient | 1 | 2 | 3 | 4 |
|---|---|---|---|---|
| Protein % w/w | 21.0 | 21.0 | 21.1 | 21.0 |
| Fat % w/w | 9.8 | 9.5 | 9.9 | 9.6 |
| Carbohydrates % w/w | 20.1 | 18.7 | 19.7 | 19.6 |
| Total_Solids % w/w | 56.7 | 55.5 | 56.1 | 55.1 |
| Calcium % w/w | 0.15 | 0.584 | 0.277 | 0.152 |
| Energy_kJ/100 g | 1082.3 | 1049.1 | 1080.8 | 1066.8 |
| Energy_kcal/100 g | 257.8 | 250.1 | 257.5 | 254.2 |

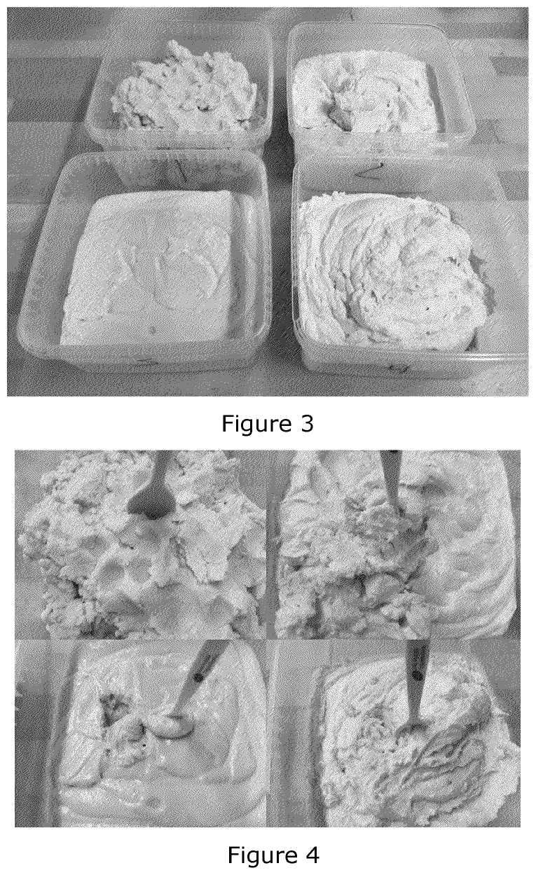

FIG. 3 shows the appearance of the compositions right after mixing. Left-hand side: composition 1 (top) and 3 (bottom). Right-hand side: composition 2 (top) and 4 (bottom). FIG. 4 shows the compositions after 3 days storage at 5° C. Left-hand side: composition 1 (top) and 3 (bottom). Right-hand side: composition 2 (top) and 4 (bottom). It can be seen from the picture that the moldability of the compositions are markedly difference.

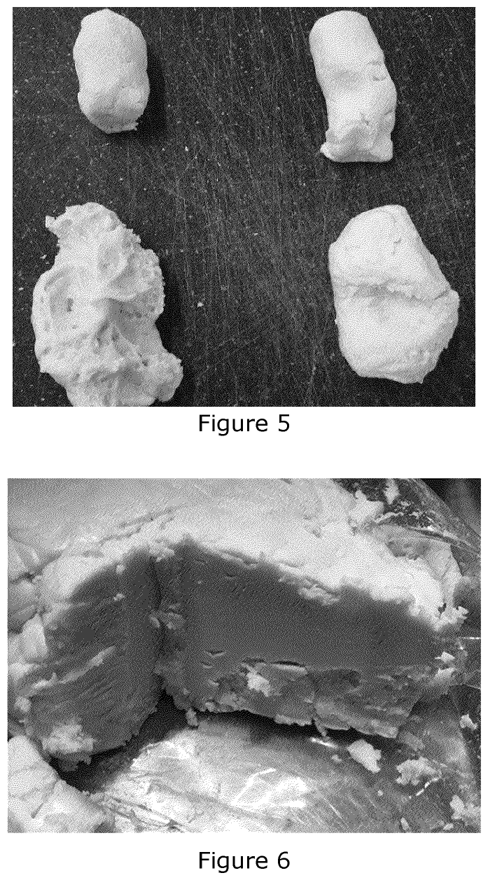

FIG. 5 shows the compositions formed as bars. Left-hand side: composition 1 (top) and 3 (bottom). Right-hand side: composition 2 (top) and 4 (bottom).

### Example 4: Preparing a Dairy-Based Product from Greek Yoghurt 20/and 8%/—Yoghurt Bar

The present example prepares a yoghurt bar from Greek yoghurt 2%/ or Greek yoghurt 10% with acid-gellable whey protein aggregates.

The composition are prepared from the ingredients shown in table 7:

| Ingrediens % w/w | 1 | 2 | 3 | 4 | 5 | 6 | 7 |
|---|---|---|---|---|---|---|---|
| Whey powder comprising approx. 75% agWPA | 31 | 34 | 34 | 32 | 30 | 28.8 | 27 |
| relative to total protein and approx. | | | | | | | |
| 50% protein relative to the weight of the | | | | | | | |
| powder | | | | | | | |
| Yoghurt, Greek style 10% fat, | 48.45 | 0 | 0 | 47 | 60 | 42.3 | 54 |
| 4.2% protein and total solids of 19% | | | | | | | |
| Yoghurt, Greek style Nostimo 2% fat, | 0 | 33 | 37 | | | | |
| 8.5% protein and total solids of 19% | | | | | | | |
| Fibre, inulin | 0 | 4 | 3 | 2 | 2 | 1.8 | 1.8 |
| Sucrose | 8 | 6 | 6 | 7 | 8 | 6.3 | 7.2 |
| Cream 38% | 12 | 22 | 19 | 12 | 0 | 10.8 | 0 |
| Flavour | 0.55 | 1 | 1 | 0 | 0 | 0 | 0 |
| Chocolate, dark 57.8 | 0 | 0 | 0 | 0 | 0 | 10 | 10 |

The dairy-based products were prepared by adding all the ingredients into the bowl of a Hobart mixer. The pH of the Greek yoghurt was 4.5. The ingredients were mixed for 1 minute at 107 RPM, 30 seconds at 198 RPM and 30 seconds at 361 RPM. The bowl was scraped. pH was measured to 5.85 and the pH was adjusted with lactic acid to a pH of about 4.5. The composition is then mixed for 30 seconds at 361 RPM. The compositions were then stored at 5 degree C. for about 16 hours before being extruded to form a bar shaped mass weighing around 50 grams and then subsequently coated with chocolate.

The content of nutrients and energy is shown in table 8:

| Nutrient | 1 | 2 | 3 | 4 | 5 | 6 | 7 |
|---|---|---|---|---|---|---|---|
| Protein % w/w | 19.2 | 20.8 | 21.0 | 19.7 | 19.2 | 18.2 | 17.8 |
| Fat % w/w | 10.7 | 10.5 | 9.4 | 10.6 | 7.3 | 13.2 | 10.3 |
| Carbohydrate % w/w | 20.5 | 20.9 | 21.0 | 20.0 | 20.5 | 23.5 | 23.9 |
| Total Solids % w/w | 53.5 | 58.9 | 57.3 | 55.1 | 51.7 | 59.5 | 56.4 |
| Lactose % w/w | 12.5 | 13.6 | 13.7 | 12.8 | 12.3 | 11.6 | 11.2 |
| Calcium % w/w | 0.14 | 0.1 | 0.2 | 0.1 | 0.1 | 0.1 | 0.1 |
| Energy kJ | 1073 | 1124.6 | 1083.6 | 1081.1 | 958.4 | 1213.8 | 1103.3 |
| Energy kcal | 255.6 | 268.1 | 258.1 | 257.7 | 227.9 | 289.7 | 262.8 |

FIG. 6 shows composition 4 prepared with whey powder comprising agWPA after mixing is finished and the composition has been stored at 5 degree C. overnight.

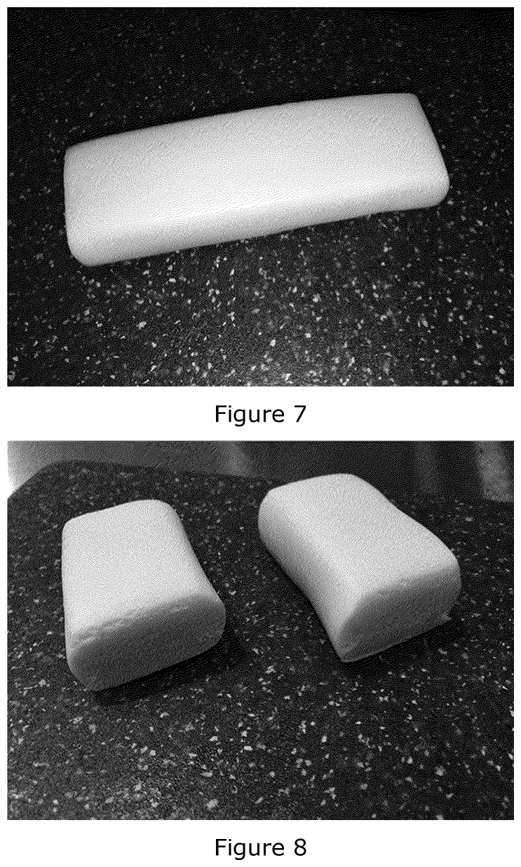

FIG. 7 shows the same composition where the composition is manually shaped into a bar.

FIG. 8 shows the manually shaped bar, which has been cut into two halves and reveals a nice uniform surface cut.

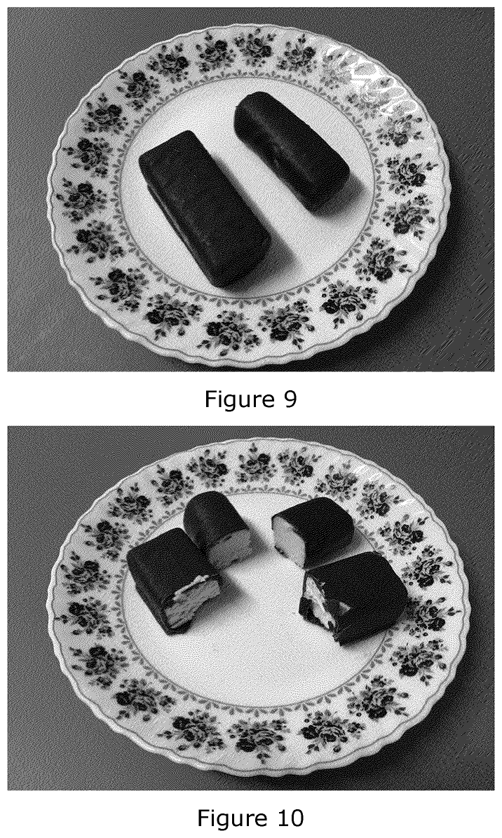

FIG. 9 show two yoghurt bars. The left one in the picture is a commercially available yoghurt bar and the one to the right is the bar made using Whey powder comprising agWPA.

FIG. 10 show the same bars as in FIG. 6, but after they have been cut in half's.

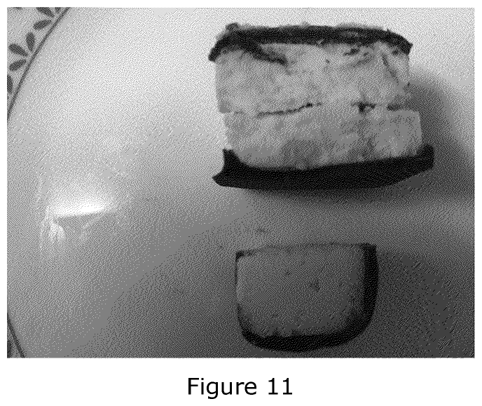

FIG. 11 show a zoom in on the cut surface of the two bars in FIG. 7. The commercially available yoghurt bar is positioned at the top and the bar made using Whey powder comprising agWPA is positioned at the bottom.

1. A method for preparing a high-protein, dairy-based product having a protein content of 14-40% w/w and a dry-matter content of at least 40% w/w, the method comprising
a) combining an acidified dairy product, acid-gellable whey protein aggregates and optionally, at least one further ingredient to obtain a mixture;
b) optionally, shaping and/or packaging the mixture, and
wherein the high-protein dairy-based product is the mixture obtained from step a) and/or step b), and wherein the acid-gellable whey protein aggregates constitute 8-20% w/w of the total weight of the dairy-based product.

2. The method according to claim 1, wherein the high-protein dairy-based product is self-supporting.

3. The method according to claim 1, wherein the dairy-based product has a dry-matter content in the range of 40-75% w/w, preferably in the range of 40-70% w/w, even more preferably in the range of 40-60% w/w, and most preferably in the range of 50-60% w/w.

4. The method according to claim 1, wherein the acid-gellable whey protein aggregates constitute in the range of 9-18% w/w of the total weight of the dairy-based product, preferably in the range of 10-16% w/w or in the range of 12-14% w/w.

5. The method according to claim 1, wherein the pH of the mixture has a pH within the range of 3.5-6.0, preferably in the range of 4.0-5.5, in the range of 4.0-5.0 or in the range of 4.2-4.5.

6. The method according to claim 1, wherein the method is carried out at a temperature in the range of 0-20 degrees C., preferably in the range of 0-15 degrees C., more preferably in the range of 5-15 degrees C. or even more preferred at a temperature of 10 degrees C.

7. The method according to claim 1, wherein the further ingredient is selected from fats, carbohydrates, vitamins, sweeteners, carbohydrate based stabilizers and mixtures thereof.

8. The method according to claim 1, wherein the mixture is stored at a temperature of 0-10 degrees C. for a period of 1-24 hours, preferably at a temperature of 0-5 degrees C. for a period of 1-24 hours or more preferably at a temperature of 0-5 degrees C. for a period of 5-16 hours.

9. The method according to claim 1, wherein the mixture is shaped by extrusion, moulding and/or by filling in a container, preferably by extrusion.

10. A high-protein dairy-based product obtainable by the method of claim 1, preferably wherein the texture of the composition is at least 20.000 g·sec.

11. The dairy-based product according to claim 10, wherein the product comprises viable lactic acid bacteria.

12. Method for producing a food product comprising the steps of:
a) providing a dairy-based product according to claim 10;
b) combining the dairy-based product with at least one further ingredient to obtain the food product; and
c) optionally, packaging the food product.

13. Food product obtainable by the method of claim 12, comprising the dairy-based product and at least one further ingredient.

14. Food product according to claim 13, wherein the product is selected from the group consisting of a yoghurt bar, a dessert, a cake, a sports bar and a protein bar.

15. Use of the high-protein dairy-based product according to claim 10.

16. Use of the food product according to claim 13, for increasing the intake of protein.
